(19) United States
(12) Patent Application Publication
(10) Pub. No.: US 2024/0152322 A1
(43) Pub. Date: May 9, 2024

(54) ARTIFICIAL INTELLIGENCE ACCELERATORS

(71) Applicant: SK hynix Inc., Icheon-si Gyeonggi-do (KR)

(72) Inventor: Seong Ju LEE, Icheon-si Gyeonggi-do (KR)

(73) Assignee: SK hynix Inc., Icheon-si Gyeonggi-do (KR)

(21) Appl. No.: 18/407,854

(22) Filed: Jan. 9, 2024

Related U.S. Application Data
(63) Continuation-in-part of application No. 17/503,770, filed on Oct. 18, 2021.

(30) Foreign Application Priority Data
May 18, 2021 (KR) 10-2021-0064088

(51) Int. Cl. G06F 7/485; G06F 5/01; G06F 7/556

(52) U.S. Cl. CPC G06F 7/485; G06F 5/012; G06F 7/556

(57) ABSTRACT

An accumulator includes an exponent data latch circuit configured to output first exponent data of input data and second exponent data of latch data in synchronization with a first clock signal, a mantissa data latch circuit configured to output first mantissa data of the input data and second mantissa data of the latch data in synchronization with an edge of a second clock signal delayed by a delay time period later than an edge of the first clock signal, an exponent processing circuit configured to perform an exponent processing operation that generates first shift data and second shift data based on the first exponent data and the second exponent data transmitted from the exponent data latch circuit, and a mantissa processing circuit configured to shift the first mantissa data and the second mantissa data transmitted from the mantissa data latch circuit by the first shift data and the second shift data, respectively.

### CROSS-REFERENCE TO RELATED APPLICATIONS

This is a continuation-in-part of U.S. patent application Ser. No. 17/503,770, filed on Oct. 18, 2021, and claims priority under 35 U.S.C. § 119(a) to Korean patent application number 10-2021-0064088 filed on May 18, 2021, in the Korean Intellectual Property Office, the entire disclosure of which is incorporated by reference herein, which is incorporated herein by reference in its entirety.

### BACKGROUND

### 1. Technical Field

Various embodiments of the present teachings generally relate to accumulator and, more particularly, to accumulator configured to perform a floating point operation.

### 2. Related Art

Recently, interest in artificial intelligence (AI) has been increasing not only in the information technology industry but also in the financial and medical industries. Accordingly, in various fields, the artificial intelligence, more precisely, the introduction of deep learning is considered and prototyped. In general, techniques for effectively learning deep neural networks (DNNs) or deep networks having the increased layers as compared with general neural networks to utilize the deep neural networks (DNNs) or the deep networks in pattern recognition or inference are commonly referred to as the deep learning.

One of backgrounds or causes of this widespread interest may be due to the improved performance of a processor performing arithmetic operations. To improve the performance of the artificial intelligence, it may be necessary to increase the number of layers constituting a neural network in the artificial intelligence to educate the artificial intelligence. This trend has continued in recent years, which has led to an exponential increase in the amount of computation required for the hardware that actually does the computation. Moreover, if the artificial intelligence employs a general hardware system including a memory and a processor which are separated from each other, the performance of the artificial intelligence may be degraded due to limitation of the amount of data communication between the memory and the processor. In order to solve this problem, a processing-in-memory (PIM) device including a processor and a memory which are integrated in one semiconductor chip has been employed as an artificial intelligence accelerator. Because the PIM device directly performs arithmetic operations in the PIM device using data stored in the memory of the PIM device as input data, a data processing speed in the neural network may be improved.

### SUMMARY

According to an embodiment, an accumulator may include an exponent data latch circuit configured to output first exponent data of input data and second exponent data of latch data in synchronization with a first clock signal, a mantissa data latch circuit configured to output first mantissa data of the input data and second mantissa data of the latch data in synchronization an edge of a second clock signal delayed by a delay time period later than an edge of the first clock signal, an exponent processing circuit configured to perform an exponent processing operation that generates first shift data and second shift data based on the first exponent data and the second exponent data transmitted from the exponent data latch circuit, and a mantissa processing circuit configured to shift the first mantissa data and the second mantissa data transmitted from the mantissa data latch circuit by the first shift data and the second shift data, respectively.

### BRIEF DESCRIPTION OF THE DRAWINGS

Certain features of the disclosed technology are illustrated by various embodiments with reference to the attached drawings, in which:

FIG. 1 is a block diagram illustrating an artificial intelligence accelerator according to an embodiment of the present disclosure;

FIG. 2 is a timing diagram illustrating an accumulative adding calculation of an accumulative addition circuit included in the artificial intelligence accelerator of FIG. 1;

FIG. 3 illustrates an example of a matrix multiplying calculation executed by a multiplication/accumulation (MAC) operation of the artificial intelligence accelerator of FIG. 1;

FIG. 4 illustrates a process of storing weight data in FIG. 3 into a left memory bank and a right memory bank included in the artificial intelligence accelerator of FIG. 1;

FIG. 5 illustrates a process of storing vector data in FIG. 3 into a first global buffer and a second global buffer included in the artificial intelligence accelerator of FIG. 1;

FIG. 6 is a block diagram illustrating an example of configurations and operations of a left multiplication circuit, a right multiplication circuit, and an integrated adder tree included in the artificial intelligence accelerator of FIG. 1;

FIG. 7 is a block diagram illustrating an example of configurations and operations of a left accumulator and a right accumulator constituting an accumulative addition circuit included in the artificial intelligence accelerator of FIG. 1;

FIG. 8 is a block diagram illustrating an example of a configuration of a left accumulative adder included in a left accumulator shown in FIG. 7;

FIG. 9 is a block diagram illustrating an example of a configuration of an exponent operation circuit included in the left accumulative adder of FIG. 8;

FIG. 10 is a block diagram illustrating an example of a configuration of a mantissa operation circuit included in the left accumulative adder of FIG. 8;

FIG. 11 is a block diagram illustrating an example of a configuration of a normalizer included in the left accumulative adder of FIG. 8;

FIG. 12 illustrates an operation of processing exponent part data and mantissa part data during an accumulative adding calculation of the left accumulative adder described with reference to FIGS. 8 to 11;

FIG. 13 illustrates operation timings of a left accumulative adder and a right accumulative adder shown in FIG. 7;

FIG. 14 is a block diagram illustrating an artificial intelligence accelerator according to another embodiment of the present disclosure;

FIG. 15 is a block diagram illustrating an example of a configuration of a left multiplication/addition circuit included in the artificial intelligence accelerator of FIG. 14;

FIG. 16 is a block diagram illustrating an example of a configuration of a right multiplication/addition circuit included in the artificial intelligence accelerator of FIG. 14;

FIG. 17 is a block diagram illustrating an artificial intelligence accelerator according to yet another embodiment of the present disclosure;

FIG. 18 is a block diagram illustrating an example of a configuration of a first MAC unit included in the artificial intelligence accelerator of FIG. 17;

FIG. 19 is a block diagram illustrating another example of a configuration of a first MAC unit included in the artificial intelligence accelerator of FIG. 17;

FIG. 20 illustrates a matrix multiplying calculation executed by a MAC operation of the artificial intelligence accelerator of FIG. 17;

FIG. 21 is a block diagram illustrating an accumulator according to an embodiment of the present disclosure;

FIG. 22 is a block diagram illustrating an embodiment of a clock generation circuit included in the accumulator of FIG. 21;

FIG. 23 is a timing diagram illustrating an embodiment of waveforms of a first clock signal and a second clock signal output from the clock generation circuit of FIG. 22;

FIG. 24 is a timing diagram illustrating an example of a time required for an accumulating operation in the accumulator of FIG. 21;

FIG. 25 is a block diagram illustrating an embodiment of an exponent processing circuit included in the accumulator of FIG. 21;

FIG. 26 is a block diagram illustrating an embodiment of a mantissa processing circuit included in the accumulator of FIG. 21;

FIG. 27 is a block diagram illustrating an embodiment of a normalization circuit included in the accumulator of FIG. 21; and

FIG. 28 is a timing diagram illustrating in more detail an example of a time required for an accumulating operation in the accumulator of FIG. 21.

### DETAILED DESCRIPTION

In the following description of embodiments, it will be understood that the terms “first” and “second” are intended to identify elements, but not used to define a particular number or sequence of elements. In addition, when an element is referred to as being located “on,” “over,” “above,” “under,” or “beneath” another element, it is intended to mean relative positional relationship, but not used to limit certain cases for which the element directly contacts the other element, or at least one intervening element is present between the two elements. Accordingly, the terms such as “on,” “over,” “above,” “under,” “beneath,” “below,” and the like that are used herein are for the purpose of describing particular embodiments only and are not intended to limit the scope of the present disclosure. Further, when an element is referred to as being “connected” or “coupled” to another element, the element may be electrically or mechanically connected or coupled to the other element directly, or may be electrically or mechanically connected or coupled to the other element indirectly with one or more additional elements between the two elements. Moreover, when a parameter is referred to as being “predetermined,” it may be intended to mean that a value of the parameter is determined in advance of when the parameter is used in a process or an algorithm. The value of the parameter may be set when the process or the algorithm starts or may be set during a period in which the process or the algorithm is executed. A logic “high” level and a logic “low” level may be used to describe logic levels of electric signals. A signal having a logic “high” level may be distinguished from a signal having a logic “low” level. For example, when a signal having a first voltage corresponds to a signal having a logic “high” level, a signal having a second voltage may correspond to a signal having a logic “low” level. In an embodiment, the logic “high” level may be set as a voltage level which is higher than a voltage level of the logic “low” level. Meanwhile, logic levels of signals may be set to be different or opposite according to embodiment. For example, a certain signal having a logic “high” level in one embodiment may be set to have a logic “low” level in another embodiment.

Various embodiments of the present disclosure will be described hereinafter in detail with reference to the accompanying drawings. However, the embodiments described herein are for illustrative purposes only and are not intended to limit the scope of the present disclosure. Although the following embodiments are described in conjunction with dynamic random access memory (DRAM) devices, it may be apparent to those of ordinary skill in the art that the present disclosure is not limited to the DRAM devices. For example, the following embodiments may be equally applied to various memory devices such as an SRAM, a synchronous DRAM (SDRAM), a double data rate synchronous DRAM (DDR SDRAM, DDR2 SDRAM, or DDR3 SDRAM), a graphic double data rate synchronous DRAM (GDDR, GDDR2, GDDR3, or the like), a quad data rate DRAM (QDR DRAM), a Rambus extreme data rate DRAM (Rambus XDR DRAM), a fast page mode DRAM (FPM DRAM), a video DRAM (VDRAM), an extended data output DRAM (EDO DRAM), a burst extended data output DRAM (BEDO DRAM), a multibank DRAM (MDRAM), a synchronous graphic RAM (SGRAM), or another type DRAM.

Various embodiments are directed to artificial intelligence accelerators.

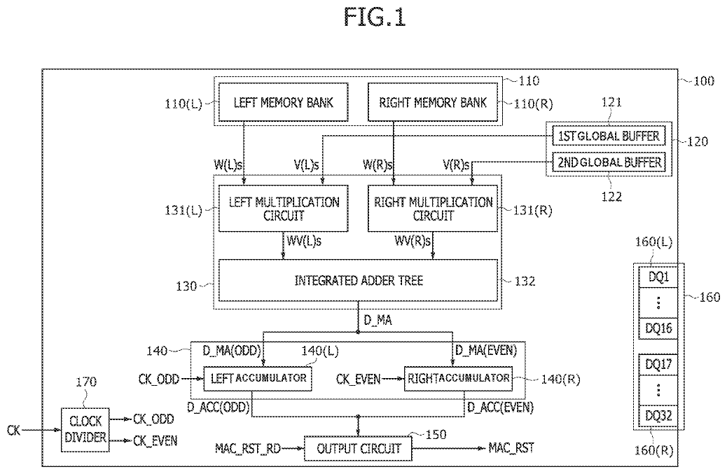

FIG. 1 is a block diagram illustrating an artificial intelligence (AI) accelerator 100 according to an embodiment of the present disclosure. In an embodiment, the AI accelerator 100 may have a processing-in-memory (PIM) structure performing an arithmetic operation in a memory structural device. Alternatively, the AI accelerator 100 may have a structure of a graphic processing unit (GPU), an application specific integrated circuit (ASIC) specified to deep learning operations, or a field programmable gate array (FPGA) based on a programmable logic. Hereinafter, the following embodiments will be described in conjunction with a case that the AI accelerator 100 performs a MAC operation. However, the following embodiments may be merely some examples of the present disclosure. Accordingly, the AI accelerator 100 may be configured to perform other arithmetic operations (including an accumulative adding calculation) other than the MAC operation.

Referring to FIG. 1, the AI accelerator 100 may include a first memory circuit 110, a second memory circuit 120, a multiplication circuit/adder tree 130, an accumulative addition circuit 140, an output circuit 150, a data input/output (I/O) circuit 160, a clock divider 170.

The first memory circuit 110 may include a left memory bank 110(L) and a right memory bank 110(R) which are disposed to be physically distinguished from each other. The left memory bank 110(L) and the right memory bank 110(R) may have substantially the same memory size. The left memory bank 110(L) may store left weight data W(L)s used for a MAC operation, and the right memory bank 110(R) may store right weight data W(R)s used for the MAC operation. The left memory bank 110(L) may transmit the left weight data W(L)s to the multiplication circuit/adder tree 130 in response to a control signal for controlling the MAC operation, and the right memory bank 110(R) may transmit the right weight data W(R)s to the multiplication circuit/adder tree 130 in response to a control signal for controlling the MAC operation.

The second memory circuit 120 may include a first global buffer 121 and a second global buffer 122. The first global buffer 121 may store left vector data V(L)s used for the MAC operation, and the second global buffer 122 may store right vector data V(R)s used for the MAC operation. The first global buffer 121 may transmit the left vector data V(L)s to the multiplication circuit/adder tree 130 in response to a control signal for controlling the MAC operation, and the second global buffer 122 may transmit the right vector data V(R)s to the multiplication circuit/adder tree 130 in response to a control signal for controlling the MAC operation. Although not shown in FIG. 1, the left vector data V(L)s and the right vector data V(R)s may be transmitted from the first global buffer 121 and the second global buffer 122 to the multiplication circuit/adder tree 130 through a global data I/O line (GIO).

The multiplication circuit/adder tree 130 may perform a multiplying calculation and an adding calculation using the weight data W(L)s and W(R)s and the vector data V(L)s ad V(R)s outputted from the first and second memory circuits 110 and 120 as input data, thereby generating and outputting multiplication/addition result data D_MA. The multiplication circuit/adder tree 130 may include a left multiplication circuit 131(L), a right multiplication circuit 131(R), and an integrated adder tree 132. The left multiplication circuit 131(L) may receive the left weight data W(L)s and the left vector data V(L)s from respective ones of the left memory bank 110(L) and the first global buffer 121. The left multiplication circuit 131(L) may perform a multiplying calculation on the left weight data W(L)s and the left vector data V(L)s to generate and output left multiplication result data WV(L)s. The right multiplication circuit 131(R) may receive the right weight data W(R)s and the right vector data V(R)s from respective ones of the right memory bank 110(R) and the second global buffer 122. The right multiplication circuit 131(R) may perform a multiplying calculation on the right weight data W(R)s and the right vector data V(R)s to generate and output right multiplication result data WV(R)s. The left multiplication result data WV(L)s and the right multiplication result data WV(R)s may be transmitted to the integrated adder tree 132. The integrated adder tree 132 may perform an adding calculation on the left multiplication result data WV(L)s and the right multiplication result data WV(R)s outputted from respective ones of the left multiplication circuit 131(L) and the right multiplication circuit 131(R), thereby generating and outputting the multiplication/addition result data D_MA.

The accumulative addition circuit 140 may perform an accumulative adding calculation for adding the multiplication/addition result data D_MA outputted from the multiplication circuit/adder tree 130 to latched data generated by a previous accumulative adding calculation, thereby generating and outputting accumulated data D_ACC. The accumulative addition circuit 140 may include a left accumulator 140(L) and a right accumulator 140(R). The left accumulator 140(L) and the right accumulator 140(R) may alternately receive the multiplication/addition result data D_MA from the multiplication circuit/adder tree 130. For example, the left accumulator 140(L) may receive odd-numbered multiplication/addition result data D_MA(ODD) from the multiplication circuit/adder tree 130, and the right accumulator 140(R) may receive even-numbered multiplication/addition result data D_MA(EVEN) from the multiplication circuit/adder tree 130. The left accumulator 140(L) may perform an accumulative adding calculation for adding the odd-numbered multiplication/addition result data D_MA(ODD) outputted from the multiplication circuit/adder tree 130 to the latched data generated by a previous accumulative adding calculation, thereby generating and outputting odd-numbered accumulated data D_ACC(ODD). The accumulative adding calculation of the left accumulator 140(L) may be performed in synchronization with an odd clock signal CK_ODD. The right accumulator 140(R) may perform an accumulative adding calculation for adding the even-numbered multiplication/addition result data D_MA(EVEN) outputted from the multiplication circuit/adder tree 130 to the latched data generated by a previous accumulative adding calculation, thereby generating and outputting even-numbered accumulated data D_ACC(EVEN). The accumulative adding calculation of the right accumulator 140(R) may be performed in synchronization with an even clock signal CK_EVEN.

The output circuit 150 may receive the odd-numbered accumulated data D_ACC(ODD) or the even-numbered accumulated data D_ACC(EVEN) from the accumulative addition circuit 140. The output circuit 150 may output the odd-numbered accumulated data D_ACC(ODD) or the even-numbered accumulated data D_ACC(EVEN) as MAC result data MAC_RST corresponding to a result of a final MAC operation in response to a MAC result read signal MAC_RST_RD having a first logic level such as a logic “high” level. A logic level of the MAC result read signal MAC_RST_RD may change from a logic “low” level into a logic “high” level when the odd-numbered accumulated data D_ACC(ODD) or the even-numbered accumulated data D_ACC(EVEN) generated by termination of the MAC operations on all of the weight data W(L)s and W(R)s and all of the vector data V(L)s and V(R)s are transmitted to the output circuit 150.

The data I/O circuit 160 may provide a means for data transmission between the AI accelerator 100 and an external device such as a host or a controller. The data I/O circuit 160 may include left data I/O terminals 160(L) and right data I/O terminals 160(R). The left data I/O terminals 160(L) may provide transmission paths of read data outputted from the left memory bank 110(L) or write data inputted to the left memory bank 110(L). In an embodiment, the left data I/O terminals 160(L) may include a plurality of data I/O terminals, for example, first to sixteenth data I/O terminals DQ1˜DQ16. The right data I/O terminals 160(R) may provide transmission paths of read data outputted from the right memory bank 110(R) or write data inputted to the right memory bank 110(R). In an embodiment, the right data I/O terminals 160(R) may include a plurality of data I/O terminals, for example, seventeenth to 32^{nd} data I/O terminals DQ17˜DQ32. The left data I/O terminals 160(L) and the right data I/O terminals 160(R) may provide transmission paths of the MAC result data MAC_RST outputted from the output circuit 150.

The clock divider 170 may divide a clock signal CK inputted to the AI accelerator 100 to generate and output the odd clock signal CK_ODD and the even clock signal CK_EVEN. The odd clock signal CK_ODD may be comprised of only odd pulses among pulses of the clock signal CK, and the even clock signal CK_EVEN may be comprised of only even pulses among the pulses of the clock signal CK. Thus, each of the odd clock signal CK_ODD and the even clock signal CK_EVEN may have a cycle which is twice a cycle of the clock signal CK. In an embodiment, the clock divider 170 may delay the clock signal CK by a certain time to generate and output the odd clock signal CK_ODD and the even clock signal CK_EVEN having a cycle which is twice a cycle of the clock signal CK. The clock divider 170 may transmit the odd clock signal CK_ODD to the left accumulator 140(L) of the accumulative addition circuit 140 and may transmit the even clock signal CK_EVEN to the right accumulator 140(R) of the accumulative addition circuit 140.

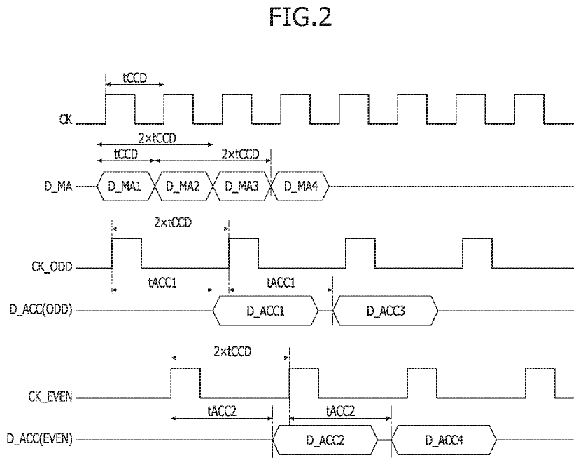

FIG. 2 is a timing diagram illustrating an accumulative adding calculation of the accumulative addition circuit 140 included in the AI accelerator 100 of FIG. 1. In the present embodiment, it may be assumed that the clock signal CK inputted to the clock divider 170 may have a cycle which is equal to a CAS to CAS delay time “tCCD” corresponding to an interval time between column addresses. In addition, it may be assumed that a time it takes the multiplication circuit/adder tree 130 to perform a multiplying calculation and an adding calculation is shorter than the CAS to CAS delay time “tCCD”.

Referring to FIGS. 1 and 2, first to fourth multiplication/addition result data D_MA1˜D_MA4 outputted from the multiplication circuit/adder tree 130 may be alternately transmitted to the left accumulator 140(L) and the right accumulator 140(R). Thus, the odd-numbered multiplication/addition result data D_MA(ODD) (i.e., the first and third multiplication/addition result data D_MA1 and D_MA3) may be transmitted to the left accumulator 140(L), and the even-numbered multiplication/addition result data D_MA(EVEN) (i.e., the second and fourth multiplication/addition result data D_MA2 and D_MA4) may be transmitted to the right accumulator 140(R). In an embodiment, the first to fourth multiplication/addition result data D_MA1—D_MA4 may be outputted from the multiplication circuit/adder tree 130 at an interval time of the CAS to CAS delay time “tCCD”. Accordingly, the left accumulator 140(L) may receive the first and third multiplication/addition result data D_MA1 and D_MA3 at an interval time of twice the CAS to CAS delay time “tCCD”. Similarly, the right accumulator 140(R) may receive the second and fourth multiplication/addition result data D_MA2 and D_MA4 at an interval time of twice the CAS to CAS delay time “tCCD”.

The left accumulator 140(L) may be synchronized with a first pulse of the odd clock signal CK_ODD to perform an accumulative adding calculation on the first multiplication/addition result data D_MA1 and the latched data. The first pulse of the odd clock signal CK_ODD may be generated at a point in time when a certain time elapses from a point in time when a first pulse of the clock signal CK occurs. Because a first accumulative adding calculation is performed, a latch circuit of the left accumulator 140(L) may be reset to have a value of zero as the latched data. Thus, the left accumulator 140(L) may terminate the accumulative adding calculation at a point in time when a first accumulative addition time “tACC1” elapses from a point in time when the first pulse of the odd clock signal CK_ODD is generated, thereby generating first accumulated data D_ACC1 as first odd-numbered accumulated data D_ACC(ODD). The first accumulative addition time “tACC1” may mean a time it takes the left accumulator 140(L) to perform an accumulative adding calculation. The first accumulated data D_ACC1 may be used as latched data during a next accumulative adding calculation of the left accumulator 140(L).

The right accumulator 140(R) may be synchronized with a first pulse of the even clock signal CK_EVEN to perform an accumulative adding calculation on the second multiplication/addition result data D_MA2 and the latched data. The first pulse of the even clock signal CK_EVEN may be generated at a point in time when a certain time elapses from a point in time when a second pulse of the clock signal CK occurs. Because the first accumulative adding calculation is performed, a latch circuit of the right accumulator 140(R) may also be reset to have a value of zero as the latched data. Thus, the right accumulator 140(R) may terminate the accumulative adding calculation at a point in time when a second accumulative addition time “tACC2” elapses from a point in time when the first pulse of the even clock signal CK_EVEN is generated, thereby generating second accumulated data D_ACC2 as first even-numbered accumulated data D_ACC(EVEN). The second accumulative addition time “tACC2” may mean a time it takes the right accumulator 140(R) to perform an accumulative adding calculation. The second accumulated data D_ACC2 may be used as latched data during a next accumulative adding calculation of the right accumulator 140(R).

The left accumulator 140(L) may be synchronized with a second pulse of the odd clock signal CK_ODD to perform an accumulative adding calculation on the third multiplication/addition result data D_MA3 and the latched data (i.e., the first accumulated data D_ACC1). The second pulse of the odd clock signal CK_ODD may be generated at a point in time when a certain time elapses from a point in time when a third pulse of the clock signal CK occurs. The left accumulator 140(L) may terminate the accumulative adding calculation at a point in time when the first accumulative addition time “tACC1” elapses from a point in time when the second pulse of the odd clock signal CK_ODD is generated, thereby generating third accumulated data D_ACC3 as second odd-numbered accumulated data D_ACC(ODD). The third accumulated data D_ACC3 may be used as latched data during a next accumulative adding calculation of the left accumulator 140(L).

The right accumulator 140(R) may be synchronized with a second pulse of the even clock signal CK_EVEN to perform an accumulative adding calculation on the fourth multiplication/addition result data D_MA4 and the latched data (i.e., the second accumulated data D_ACC2). The second pulse of the even clock signal CK_EVEN may be generated at a point in time when a certain time elapses from a point in time when a fourth pulse of the clock signal CK occurs. The right accumulator 140(R) may terminate the accumulative adding calculation at a point in time when the second accumulative addition time “tACC2” elapses from a point in time when the second pulse of the even clock signal CK_EVEN is generated, thereby generating fourth accumulated data D_ACC4 as second even-numbered accumulated data D_ACC(EVEN). The fourth accumulated data D_ACC4 may be used as latched data during a next accumulative adding calculation of the right accumulator 140(R).

As described above, the first accumulative addition time “tACC1” it takes the left accumulator 140(L) to perform the accumulative adding calculation may be longer than the CAS to CAS delay time “tCCD” and may be shorter than twice the CAS to CAS delay time “tCCD”. Similarly, the second accumulative addition time “tACC2” it takes the right accumulator 140(R) to perform the accumulative adding calculation may also be longer than the CAS to CAS delay time “tCCD” and may be shorter than twice the CAS to CAS delay time “tCCD”. In general, in the event that the multiplication/addition result data D_MA are generated at an interval time of the CAS to CAS delay time “tCCD” and the accumulative addition time “tACC” is longer than the CAS to CAS delay time “tCCD”, a point in time when the multiplication/addition result data D_MA are transmitted to an accumulative adder of an accumulator is inconsistent with a point in time when the latched data are transmitted to the accumulative adder of the accumulator. Thus, in such a case, it may be necessary to adjust the CAS to CAS delay time “tCCD” during the MAC operation. However, in case of the AI accelerator 100 according to the present embodiment, the left accumulator 140(L) and the right accumulator 140(R) may perform an accumulative adding calculation within the first accumulative addition time “tACC1” and the second accumulative addition time “tACC2”, which are shorter than twice the CAS to CAS delay time “tCCD”, respectively. Thus, it may be unnecessary to adjust the CAS to CAS delay time “tCCD” during the MAC operation. In addition, in the event that each memory bank is divided into the left memory bank 110(L) and the right memory bank 110(R), a left MAC operator and a right MAC operator may be disposed to be allocated to respective ones of the left memory bank 110(L) and the right memory bank 110(R). Each of the left MAC operator and the right MAC operator may include an accumulator. In the AI accelerator 100 according to the present embodiment, the left accumulator 140(L) may be realized using an accumulator included in the left MAC operator, and the right accumulator 140(R) may be realized using an accumulator included in the right MAC operator. Thus, it may be unnecessary to additionally dispose accumulators occupying a relatively large area in the AI accelerator 100. Accordingly, it may be possible to realize compact AI accelerators.

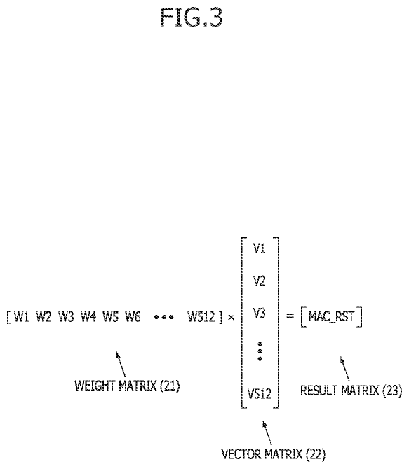

FIG. 3 illustrates an example of a matrix multiplying calculation executed by a MAC operation of the AI accelerator 100 of FIG. 1. Referring to FIG. 3, the AI accelerator 100 may perform a matrix-vector multiplying calculation on a weight matrix 21 and a vector matrix 22 to generate a result matrix 23. The present embodiment will be described in conjunction with a case that the weight matrix 21 is a ‘1×512’ matrix having one row and 512 columns, the vector matrix 22 is a ‘512×1’ matrix having 512 rows and one column, and the result matrix 23 is a ‘1×1’ matrix having one row and one column. The weight matrix 21 may have 512 elements corresponding to 512 sets of weight data W1˜W512 (i.e., first to 512th weight data W1˜W512). The vector matrix 22 may also have 512 elements corresponding to 512 sets of vector data V1˜V512 (i.e., first to 512^{th} vector data V1˜V512). The result matrix 23 may have one element corresponding to one set of the MAC result data MAC_RST. The MAC result data MAC_RST of the result matrix 23 may be generated by a matrix-vector multiplying calculation on the weight data W1˜W512 and the vector data V1˜V512. Hereinafter, it may be assumed that each of the first to 512^{th} weight data W1˜W512 and each of the first to 512^{th} vector data V1˜V512 have an IEEE 754 format (i.e., 32-bit single-precision floating-point format).

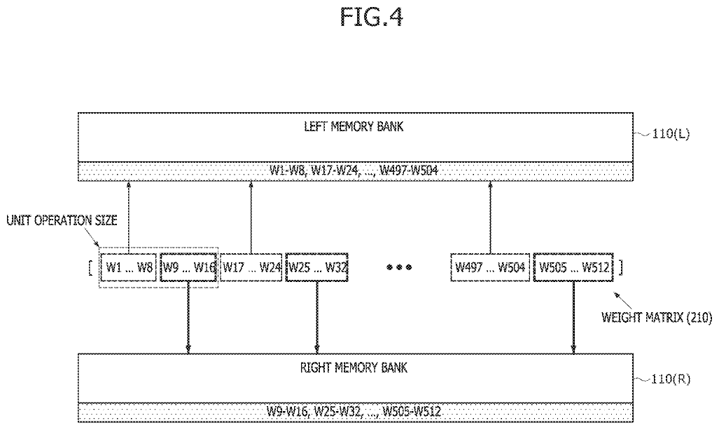

FIG. 4 illustrates a process of storing the weight data W1˜W512 of FIG. 3 into the left memory bank 110(L) and the right memory bank 110(R) included in the AI accelerator 100 of FIG. 1. As described with reference to FIG. 1, the weight data W1˜W512 used for the MAC operation may be stored in the left memory bank 110(L) and the right memory bank 110(R). Hereinafter, the weight data stored in the left memory bank 110(L) will be referred to as ‘left weight data’, and the weight data stored in the right memory bank 110(R) will be referred to as ‘right weight data’.

Referring to FIG. 4, the weight data W1˜W512 of the weight matrix 21 illustrated in FIG. 3 may be evenly allocated to the left memory bank 110(L) and the right memory bank 110(R) by a unit operation size. The unit operation size may be defined as a size of the weigh data (or the vector data) which are used for a single MAC operation of the AI accelerator 100 illustrated in FIG. 1. The unit operation size may be determined according to a hardware configuration of the multiplication circuit/adder tree 130 included in the AI accelerator 100. Hereinafter, it may be assumed that a size (i.e., the unit operation size) of the weight data processed by a single arithmetic operation of the multiplication circuit/adder tree 130 is 512 bits. As described with reference to FIG. 3, because each set of the plural sets of the weight data W1˜W512 and the plural sets of the vector data V1˜V512 has 32 bits, 16 sets of the weight data may be processed by a single MAC operation of the AI accelerator 100. In such a case, the first to 512^{th} weight data W1˜W512 may be evenly allocated to both of the left memory bank 110(L) and the right memory bank 110(R) in units of 16 sets of the weight data.

Specifically, a first group of 16 sets of the weight data (i.e., the first to sixteenth weight data W1˜W16 may be evenly allocated to and stored in the left memory bank 110(L) and the right memory bank 110(R). That is, the first to eighth weight data W1˜W8 may be stored in the left memory bank 110(L), and the ninth to sixteenth weight data W9˜W16 may be stored in the right memory bank 110(R). A second group of 16 sets of the weight data (i.e., the seventeenth to 32^{nd} weight data W17˜W32) may also be evenly allocated to and stored in the left memory bank 110(L) and the right memory bank 110(R). That is, the seventeenth to 24^{th} weight data W17˜W24 may be stored in the left memory bank 110(L), and the 25^{th} to 32^{nd} weight data W25˜W32 may be stored in the right memory bank 110(R). Similarly, a 32^{nd} group of 16 sets of the weight data (i.e., the 497^{th} to 512^{th} weight data W497˜W512) may also be evenly allocated to and stored in the left memory bank 110(L) and the right memory bank 110(R). That is, the 497^{th} to 504^{th} weight data W497˜W504 may be stored in the left memory bank 110(L), and the 505^{th} to 512^{th} weight data W505˜W512 may be stored in the right memory bank 110(R).

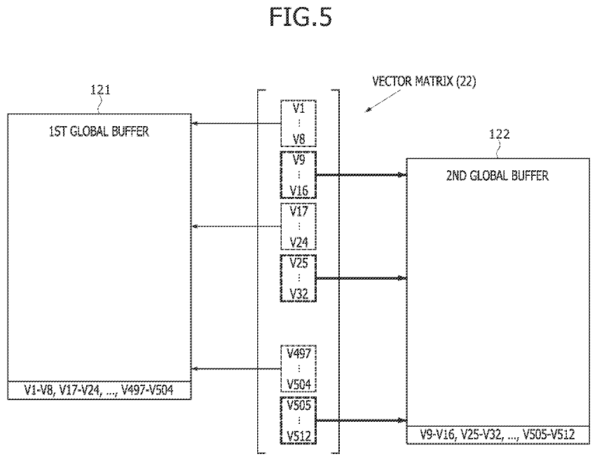

FIG. 5 illustrates a process of storing the vector data V1˜V512 of FIG. 3 into the first global buffer 121 and the second global buffer 122 included in the AI accelerator 100 of FIG. 1. Referring to FIG. 5, the vector data V1˜V512 the vector matrix 22 illustrated in FIG. 3 may be evenly allocated to the first global buffer 121 and the second global buffer 122 by the unit operation size. Because the unit operation size is defined as 512 bits in the present embodiment, the first to 512^{th} vector data V1˜V512 may be evenly allocated to both of the first global buffer 121 and the second global buffer 122 in units of 16 sets of the vector data. Specifically, a first group of 16 sets of the vector data (i.e., the first to sixteenth vector data V1˜V16 may be evenly allocated to and stored in the first global buffer 121 and the second global buffer 122. That is, the first to eighth vector data V1˜V8 may be stored in the first global buffer 121, and the ninth to sixteenth vector data V9˜V16 may be stored in the second global buffer 122. A second group of 16 sets of the vector data (i.e., the seventeenth to 32^{nd} vector data V17˜V32) may also be evenly allocated to and stored in the first global buffer 121 and the second global buffer 122. That is, the seventeenth to 24^{th} weight data V17˜V24 may be stored in the first global buffer 121, and the 25^{th} to 32^{nd} vector data W25˜W32 may be stored in the second global buffer 122. Similarly, a 32^{nd} group of 16 sets of the vector (i.e., the 497^{th} to 512^{th} vector data V497˜V512) may also be evenly allocated to and stored in the first global buffer 121 and the second global buffer 122. That is, the 497^{th} to 504^{th} vector data V497˜V504 may be stored in the first global buffer 121, and the 505^{th} to 512^{th} vector data V505˜V512 may be stored in the second global buffer 122.

In case of the present embodiment, because a single MAC operation is performed using 16 sets of the weight data and 16 sets of the vector data as input data, it may be necessary to iteratively perform the MAC operation 32 times in order to generate the MAC result data MAC_RST of the result matrix 23 illustrated in FIG. 3. A first MAC operation of the 32 MAC operations may be performed using the first group of 16 sets of the weight data W1˜W16 and the first group of 16 sets of the vector data V1˜V16 as input data. In such a case, the left memory bank 110(L) may transmit the first to eight weight data W1˜W8 to the left multiplication circuit 131(L), and the right memory bank 110(R) may transmit the ninth to sixteenth weight data W9˜W16 to the right multiplication circuit 131(R). In addition, the first global buffer 121 may transmit the first to eight vector data V1˜V8 to the left multiplication circuit 131(L), and the second global buffer 122 may transmit the ninth to sixteenth vector data V9˜V16 to the right multiplication circuit 131(R).

A second MAC operation of the 32 MAC operations may be performed using the second group of 16 sets of the weight data W17˜W32 and the second group of 16 sets of the vector data V17˜V32 as input data. In such a case, the left memory bank 110(L) may transmit the seventeenth to 24^{th} weight data W17˜W24 to the left multiplication circuit 131(L), and the right memory bank 110(R) may transmit the 25^{th} to 32^{nd} weight data W25˜W32 to the right multiplication circuit 131(R). In addition, the first global buffer 121 may transmit the seventeenth to 24^{th} vector data V17˜V24 to the left multiplication circuit 131(L), and the second global buffer 122 may transmit the 25^{th} to 32^{nd} vector data V25˜V32 to the right multiplication circuit 131(R). Similarly, a 32^{nd} MAC operation corresponding to the last MAC operation of the 32 MAC operations may be performed using the 32^{nd} group of 16 sets of the weight data W497˜W512 and the 32^{nd} group of 16 sets of the vector data V497˜V512 as input data. In such a case, the left memory bank 110(L) may transmit the 497^{th} to 504^{th} weight data W497˜W504 to the left multiplication circuit 131(L), and the right memory bank 110(R) may transmit the 505^{th} to 512^{th} weight data W505˜W512 to the right multiplication circuit 131(R). In addition, the first global buffer 121 may transmit the 497^{th} to 504^{th} vector data V497˜V504 to the left multiplication circuit 131(L), and the second global buffer 122 may transmit the 505^{th} to 512^{th} vector data V505˜V512 to the right multiplication circuit 131(R).

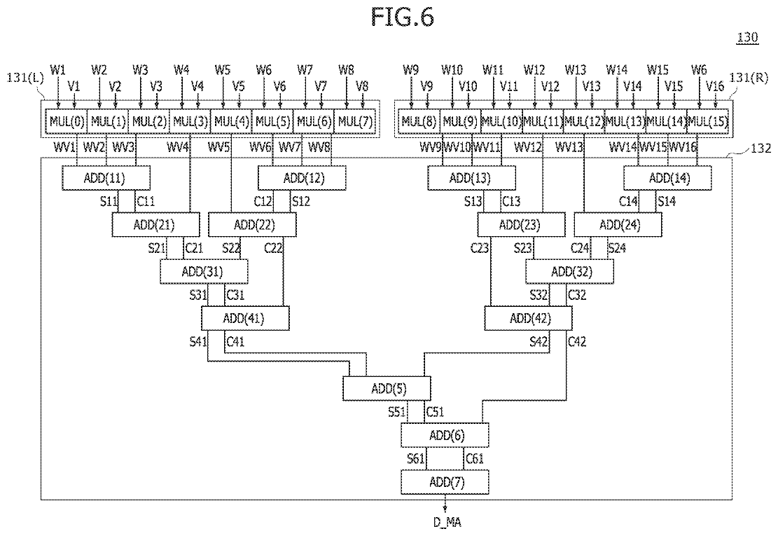

FIG. 6 is a block diagram illustrating an example of configurations and operations of the left multiplication circuit 131(L), the right multiplication circuit 131(R), and the integrated adder tree 132 included in the AI accelerator 100 of FIG. 1. Referring to FIG. 6, the left multiplication circuit 131(L) may include a plurality of multipliers, for example, first to eighth multipliers MUL(0)˜MUL(7). The first to eighth multipliers MUL(0)˜MUL(7) may receive the first to eighth weight data W1˜W8 from the left memory bank 110(L), respectively. In addition, the first to eighth multipliers MUL(0)˜MUL(7) may receive the first to eighth vector data V1˜V8 from the first global buffer (121 of FIG. 1), respectively. The first to eighth weight data W1˜W8 may constitute the left weight data W(L)s described with reference to FIG. 1, and the first to eighth vector data V1˜V8 may constitute the left vector data V(L)s described with reference to FIG. 1. The right multiplication circuit 131(R) may include a plurality of multipliers, for example, ninth to sixteenth multipliers MUL(8)˜MUL(15). The ninth to sixteenth multipliers MUL(8)˜MUL(15) may receive the ninth to sixteenth weight data W9˜W16 from the right memory bank 110(R), respectively. In addition, the ninth to sixteenth multipliers MUL(8)˜MUL(15) may receive the ninth to sixteenth vector data V9˜V16 from the second global buffer (122 of FIG. 1), respectively. The ninth to sixteenth weight data W9˜W16 may constitute the right weight data W(R)s described with reference to FIG. 1, and the ninth to sixteenth vector data V9˜V16 may constitute the right vector data V(R)s described with reference to FIG. 1.

The first to eighth multipliers MUL(0)˜MUL(7) of the left multiplication circuit 131(L) may perform multiplying calculations on the first to eighth weight data W1˜W8 and the first to eighth vector data V1˜V8 to generate first to eighth multiplication result data WV1˜WV8. For example, the first multiplier MUL(0) may perform a multiplying calculation on the first weight data W1 and the first vector data V1 to generate the first multiplication result data WV1, and the second multiplier MUL(1) may perform a multiplying calculation on the second weight data W2 and the second vector data V2 to generate the second multiplication result data WV2. In the same way, the third to eighth multipliers MUL(2)˜MUL(7) may also perform multiplying calculations on the third to eighth weight data W3˜W8 and the third to eighth vector data V3˜V8 to generate the third to eighth multiplication result data WV3˜WV8. The first to eighth multiplication result data WV1˜WV8 outputted from the first to eighth multipliers MUL(0)˜MUL(7) may be transmitted to the integrated adder tree 132.

The ninth to sixteenth multipliers MUL(8)˜MUL(15) of the right multiplication circuit 131(R) may perform multiplying calculations on the ninth to sixteenth weight data W9˜W15 and the ninth to sixteenth vector data V9˜V16 to generate ninth to sixteenth multiplication result data WV9˜WV16. For example, the ninth multiplier MUL(8) may perform a multiplying calculation on the ninth weight data W9 and the ninth vector data V9 to generate the ninth multiplication result data WV9, and the tenth multiplier MUL(9) may perform a multiplying calculation on the tenth weight data W10 and the tenth vector data V10 to generate the tenth multiplication result data WV10. In the same way, the eleventh to sixteenth multipliers MUL(10)˜MUL(15) may also perform multiplying calculations on the eleventh to sixteenth weight data W11˜W16 and the eleventh to sixteenth vector data V11˜V16 to generate the eleventh to sixteenth multiplication result data WV11˜WV16. The ninth to sixteenth multiplication result data WV9˜WV16 outputted from the ninth to sixteenth multipliers MUL(8)˜MUL(15) may be transmitted to the integrated adder tree 132.

The integrated adder tree 312 may perform an adding calculation on the first to eighth multiplication result data WV1˜WV8 outputted from the left multiplication circuit 131(L) and an adding calculation on the ninth to sixteenth multiplication result data WV9˜WV16 outputted from the right multiplication circuit 131(R). The integrated adder tree 312 may output the multiplication/addition result data D_MA as a result of the adding calculations. The integrated adder tree 312 may include a plurality of adders ADDs which are arrayed to have a hierarchical structure such as a tree structure. In the present embodiment, the integrated adder tree 312 may be comprised of a plurality of full-adders and a half-adder. However, the present embodiment is merely an example of the present disclosure. Accordingly, in some other embodiment, the integrated adder tree 312 may be comprised of only a plurality of half-adders. In the present embodiment, four full-adders ADD(11)˜ADD(14) may be disposed in a first stage located at a highest level of the integrated adder tree 312, and four full-adders ADD(21)˜ADD(24) may also be disposed in a second stage located at a second highest level of the integrated adder tree 312. In addition, two full-adders ADD(31) and ADD(32) may be disposed in a third stage located at a third highest level of the integrated adder tree 312, and two full-adders ADD(41) and ADD(42) may also be disposed in a fourth stage located at a fourth highest level of the integrated adder tree 312. Moreover, one full-adder ADD(5) may be disposed in a fifth stage located at a fifth highest level of the integrated adder tree 312, and one full-adder ADD(6) may also be disposed in a sixth stage located at a sixth highest level of the integrated adder tree 312. Furthermore, one half-adder ADD(7) may be disposed in a seventh stage located at a lowest level of the integrated adder tree 312.

The first full-adder ADD(11) in the first stage may perform an adding calculation on the first to third multiplication result data WV1˜WV3 outputted from the first to third multipliers MUL(0)˜MUL(2) of the left multiplication circuit 131(L), thereby generating and outputting added data S11 and a carry C11. The second full-adder ADD(12) in the first stage may perform an adding calculation on the sixth to eighth multiplication result data WV6˜WV8 outputted from the sixth to eighth multipliers MUL(5)˜MUL(7) of the left multiplication circuit 131(L), thereby generating and outputting added data S12 and a carry C12. The third full-adder ADD(13) in the first stage may perform an adding calculation on the ninth to eleventh multiplication result data WV9˜WV11 outputted from the ninth to eleventh multipliers MUL(8)˜MUL(10) of the right multiplication circuit 131(R), thereby generating and outputting added data S13 and a carry C13. The fourth full-adder ADD(14) in the first stage may perform an adding calculation on the fourteenth to sixteenth multiplication result data WV14˜WV16 outputted from the fourteenth to sixteenth multipliers MUL(13)˜MUL(15) of the right multiplication circuit 131(R), thereby generating and outputting added data S14 and a carry C14.

The first full-adder ADD(21) in the second stage may perform an adding calculation on the added data S11 and the carry C11 outputted from the first full-adder ADD(11) in the first stage and the fourth multiplication result data WV4 outputted from the fourth multiplier MUL(3) of the left multiplication circuit 131(L), thereby generating and outputting added data S21 and a carry C21. The second full-adder ADD(22) in the second stage may perform an adding calculation on the added data S12 and the carry C12 outputted from the second full-adder ADD(12) in the first stage and the fifth multiplication result data WV5 outputted from the fifth multiplier MUL(4) of the left multiplication circuit 131(L), thereby generating and outputting added data S22 and a carry C22. The third full-adder ADD(23) in the second stage may perform an adding calculation on the added data S13 and the carry C13 outputted from the third full-adder ADD(13) in the first stage and the twelfth multiplication result data WV12 outputted from the twelfth multiplier MUL(11) of the right multiplication circuit 131(R), thereby generating and outputting added data S23 and a carry C23. The fourth full-adder ADD(24) in the second stage may perform an adding calculation on the added data S14 and the carry C14 outputted from the fourth full-adder ADD(14) in the first stage and the thirteenth multiplication result data WV13 outputted from the thirteenth multiplier MUL(12) of the right multiplication circuit 131(R), thereby generating and outputting added data S24 and a carry C24.

The first full-adder ADD(31) in the third stage may perform an adding calculation on the added data S21 and the carry C21 outputted from the first full-adder ADD(21) in the second stage and the added data S22 outputted from the second full-adder ADD(22) in the second stage, thereby generating and outputting added data S31 and a carry C31. The second full-adder ADD(32) in the third stage may perform an adding calculation on the added data S23 outputted from the third full-adder ADD(23) in the second stage and the added data S24 and the carry C24 outputted from the fourth full-adder ADD(24) in the second stage, thereby generating and outputting added data S32 and a carry C32.

The first full-adder ADD(41) in the fourth stage may perform an adding calculation on the added data S31 and the carry C31 outputted from the first full-adder ADD(31) in the third stage and the carry C(22) outputted from the second full-adder ADD(22) in the second stage, thereby generating and outputting added data S41 and a carry C41. The second full-adder ADD(42) in the fourth stage may perform an adding calculation on the carry (C23) outputted from the third full-adder ADD(23) in the second stage and the added data S32 and the carry C32 outputted from the second full-adder ADD(32) in the third stage, thereby generating and outputting added data S42 and a carry C42.

The full-adder ADD(5) in the fifth stage may perform an adding calculation on the added data S41 and the carry C41 outputted from the first full-adder ADD(41) in the fourth stage and the added data S42 outputted from the second full-adder ADD(42) in the fourth stage, thereby generating and outputting added data S51 and a carry C51. The full-adder ADD(6) in the sixth stage may perform an adding calculation on the added data S51 and the carry C51 outputted from the full-adder ADD(5) in the fifth stage and the carry C42 outputted from the second full-adder ADD(42) in the fourth stage, thereby generating and outputting added data S61 and a carry C61. The half-adder ADD(7) in the seventh stage may perform an adding calculation on the added data S61 and the carry C61 outputted from the full-adder ADD(6) in the sixth stage, thereby generating and outputting the multiplication/addition result data D_MA. The multiplication/addition result data D_MA outputted from the half-adder ADD(7) in the seventh stage may be transmitted to the accumulative addition circuit 140.

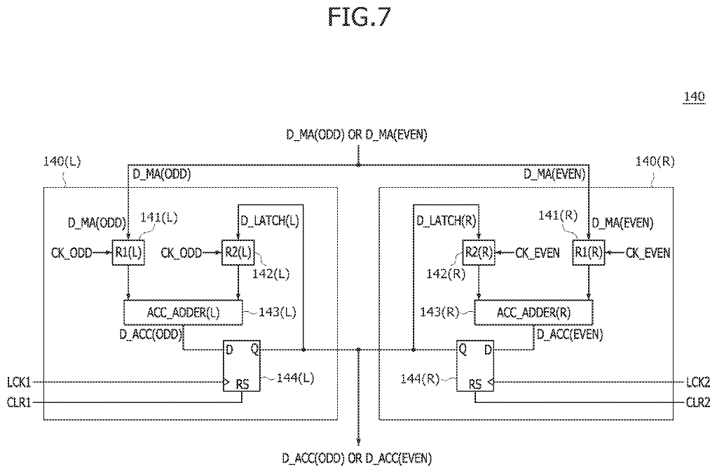

FIG. 7 is a block diagram illustrating an example of configurations and operations of the left accumulator 140(L) and the right accumulator 140(R) constituting the accumulative addition circuit 140 included in the AI accelerator 100 of FIG. 1. Referring to FIG. 7, the left accumulator 140(L) may include a first left register (R1(L)) 141(L), a second left register (R2(L)) 142(L), a left accumulative adder (ACC_ADDER(L)) 143(L), and a left latch circuit 144(L). The first left register 141(L) may receive the odd-numbered multiplication/addition result data D_MA(ODD) from the multiplication circuit/adder tree (130 of FIG. 1). The first left register 141(L) may be synchronized with the odd clock signal CK_ODD outputted from the clock divider (170 of FIG. 1) to transmit the odd-numbered multiplication/addition result data D_MA(ODD) to the left accumulative adder 143(L). The second left register 142(L) may receive left latched data D_LATCH(L) from the left latch circuit 144(L). The left latched data D_LATCH(L) may correspond to the odd-numbered accumulated data D_ACC(ODD) which are transmitted from the left accumulative adder 143(L) to the left latch circuit 144(L) and are latched by the left latch circuit 144(L) during a previous MAC operation. The second left register 142(L) may be synchronized with the odd clock signal CK_ODD outputted from the clock divider (170 of FIG. 1) to transmit the left latched data D_LATCH(L) to the left accumulative adder 143(L). In an embodiment, the second left register 142(L) may include an implied bit datum of “1.” into the left latched data D_LATCH(L) and may transmit the left latched data D_LATCH(L) including the implied bit datum to the left accumulative adder 143(L). In an embodiment, each of the first left register 141(L) and the second left register 142(L) may include at least one flip-flop.

The left accumulative adder 143(L) may perform an adding calculation on the odd-numbered multiplication/addition result data D_MA(ODD) outputted from the first left register 141(L) and the left latched data D_LATCH(L) outputted from the second left register 142(L) to generate the odd-numbered accumulated data D_ACC(ODD). The left accumulative adder 143(L) may transmit the odd-numbered accumulated data D_ACC(ODD) to an input terminal D of the left latch circuit 144(L). The left latch circuit 144(L) may latch the odd-numbered accumulated data D_ACC(ODD), which are inputted through the input terminal D, in response to a first latch clock signal LCK1 having a first logic level (e.g., a logic “high” level) inputted to a clock terminal of the left latch circuit 144(L). In addition, the left latch circuit 144(L) may output the latched data of the odd-numbered accumulated data D_ACC(ODD) through an output terminal Q of the left latch circuit 144(L) in response to the first latch clock signal LCK1 having the first logic level (e.g., a logic “high” level). Output data of the left latch circuit 144(L) may be fed back to the second left register 142(L) and may also be transmitted to the output circuit (150 of FIG. 1). When the left latch circuit 144(L) terminates latch operations of the MAC operations, the left latch circuit 144(L) may be reset in response to a first clear signal CLR1 having a logic “high” level.

The right accumulator 140(R) may include a first right register (R1(R)) 141(R), a second right register (R2(R)) 142(R), a right accumulative adder (ACC_ADDER(R)) 143(R), and a right latch circuit 144(R). The first right register 141(R) may receive the even-numbered multiplication/addition result data D_MA(EVEN) from the multiplication circuit/adder tree (130 of FIG. 1). The first right register 141(R) may be synchronized with the even clock signal CK_EVEN outputted from the clock divider (170 of FIG. 1) to transmit the even-numbered multiplication/addition result data D_MA(EVEN) to the right accumulative adder 143(R). The second right register 142(R) may receive right latched data D_LATCH(R) from the right latch circuit 144(R). The right latched data D_LATCH(R) may correspond to the even-numbered accumulated data D_ACC(EVEN) which are transmitted from the right accumulative adder 143(R) to the right latch circuit 144(R) and are latched by the right latch circuit 144(R) during a previous MAC operation. The second right register 142(R) may be synchronized with the even clock signal CK_EVEN outputted from the clock divider (170 of FIG. 1) to transmit the right latched data D_LATCH(R) to the right accumulative adder 143(R). In an embodiment, the second right register 142(R) may include an implied bit datum of “1.” into the right latched data D_LATCH(R) and may transmit the right latched data D_LATCH(R) including the implied bit datum to the right accumulative adder 143(R). In an embodiment, each of the first right register 141(R) and the second right register 142(R) may include at least one flip-flop.

The right accumulative adder 143(R) may perform an adding calculation on the even-numbered multiplication/addition result data D_MA(EVEN) outputted from the first right register 141(R) and the right latched data D_LATCH(R) outputted from the second right register 142(R) to generate the even-numbered accumulated data D_ACC(EVEN). The right accumulative adder 143(R) may transmit the even-numbered accumulated data D_ACC(EVEN) to an input terminal D of the right latch circuit 144(R). The right latch circuit 144(R) may latch the even-numbered accumulated data D_ACC(EVEN), which are inputted through the input terminal D, in response to a second latch clock signal LCK2 having the first logic level (e.g., a logic “high” level) inputted to a clock terminal of the right latch circuit 144(R). In addition, the right latch circuit 144(R) may output the latched data of the even-numbered accumulated data D_ACC(EVEN) through an output terminal Q of the right latch circuit 144(R) in response to the second latch clock signal LCK2 having the first logic level (e.g., a logic “high” level). Output data of the right latch circuit 144(R) may be fed back to the second right register 142(R) and may also be transmitted to the output circuit (150 of FIG. 1). When the right latch circuit 144(R) terminates latch operations of the MAC operations, the right latch circuit 144(R) may be reset in response to a second clear signal CLR2 having a logic “high” level.

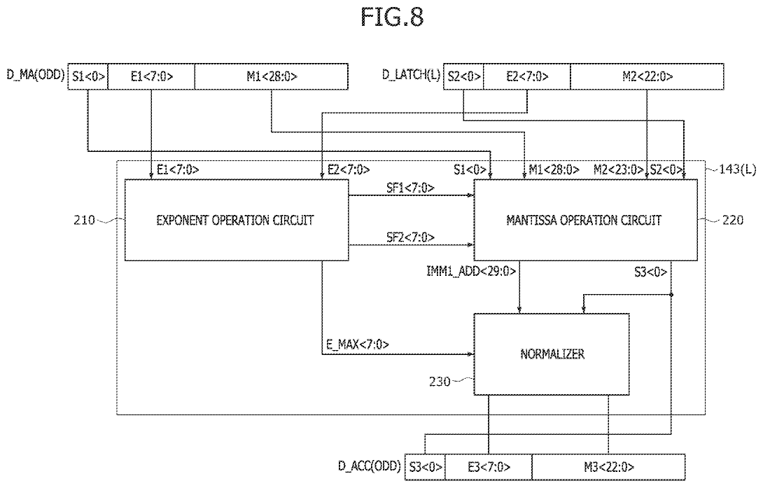

FIG. 8 is a block diagram illustrating an example of a configuration of the left accumulative adder 143(L) included in the left accumulator 140(L) shown in FIG. 7. The following descriptions on the left accumulative adder 143(L) may be equally applied to the right accumulative adder 143(R). In the present embodiment, it may be assumed that each of the first to 512^{th} weight data W1˜W512 and each of the first to 512^{th} vector data V1˜V512 have a 32-bit single-precision floating-point format, as described with reference to FIG. 3. Thus, each of the first to 512^{th} weight data W1˜W512 and each of the first to 512^{th} vector data V1˜V512 may be comprised of a sign datum having one bit, first exponent data having 8 bits, and mantissa data having 23 bits. The number of bits included in the mantissa data may increase during the adding calculation of the integrated adder tree 132 included in the multiplication circuit/adder tree 130. In the present embodiment, it may be assumed that the number of bits included in the mantissa data increases by six bits due to generation of carry bits during the adding calculation of the integrated adder tree 132 included in the multiplication circuit/adder tree 130. Accordingly, the odd-numbered multiplication/addition result data D_MA(ODD) may be comprised of a first sign datum S1<0> having one bit, first exponent data E1<7:0> having 8 bits, and first mantissa data M1<28:0> having 29 bits. Because the left latched data D_LATCH(L) are normalized during a previous additive adding calculation, the left latched data D_LATCH(L) may be comprised of a second sign datum S2<0> having one bit, second exponent data E2<7:0> having 8 bits, and second mantissa data M2<22:0> having 23 bits. An implied bit datum may be included in the second mantissa data M2<22:0> having 23 bits of the left latched data D_LATCH(L) before the second mantissa data M2<22:0> are inputted to the left accumulative adder 143(L). Thus, second mantissa data M2<23:0> having 24 bits may be inputted to the left accumulative adder 143(L).

Referring to FIG. 8, the left accumulative adder 143(L) may include an exponent operation circuit 210, a mantissa operation circuit 220, and a normalizer 230. The exponent operation circuit 210 may receive the first exponent data E1<7:0> of the odd-numbered multiplication/addition result data D_MA(ODD) from the first left register 141(L) and may also receive the second exponent data E2<7:0> of the left latched data D_LATCH(L) from the second left register 142(L). The exponent operation circuit 210 may perform an exponent operation on the first exponent data E1<7:0> and the second exponent data E2<7:0>. The exponent operation circuit 210 may generate and output maximum exponent data E_MAX<7:0>, first shift data SF1<7:0>, and second shift data SF2<7:0> as a result of the exponent operation. The maximum exponent data E_MAX<7:0> may correspond to data having a larger value out of the first shift data SF1<7:0> and the second shift data SF2<7:0>. The first shift data SF1<7:0> may have a first shift value corresponding to the number of bits that the first mantissa data M1<28:0> of the odd-numbered multiplication/addition result data D_MA(ODD) has to be shifted. The second shift data SF2<7:0> may have a second shift value corresponding to the number of bits that the second mantissa data M2<23:0> of the left latched data D_LATCH(L) has to be shifted. The first shift data SF1<7:0> and the second shift data SF2<7:0> outputted from the exponent operation circuit 210 may be transmitted to the mantissa operation circuit 220. The maximum exponent data E_MAX<7:0> outputted from the exponent operation circuit 210 may be transmitted to the normalizer 230.

The mantissa operation circuit 220 may receive the first sign datum S1<0> and the first mantissa data M1<28:0> of the odd-numbered multiplication/addition result data D_MA(ODD) from the first left register 141(L). The mantissa operation circuit 220 may also receive the second sign datum S2<0> and the second mantissa data M2<23:0> of the left latched data D_LATCH(L) from the second left register 142(L). In addition, the mantissa operation circuit 220 may receive the first shift data SF1<7:0> and the second shift data SF2<7:0> from the exponent operation circuit 210. The mantissa operation circuit 220 may perform a mantissa operation on the first mantissa data M1<28:0> and the second mantissa data M2<23:0> to generate a third sign datum S3<0> of the odd-numbered accumulated data D_ACC(ODD) and a first interim mantissa addition data IMM1_ADD<29:0>. The third sign datum S3<0> of the odd-numbered accumulated data D_ACC(ODD) and the first interim mantissa addition data IMM1_ADD<29:0> may be transmitted to the normalizer 230.

The normalizer 230 may receive the third sign datum S3<0> and the first interim mantissa addition data IMM1_ADD<29:0> from the mantissa operation circuit 220. In addition, the normalizer 230 may receive the maximum exponent data E_MAX<7:0> from the exponent operation circuit 210. The normalizer 230 may perform a normalization operation using the maximum exponent data E_MAX<7:0>, the first interim mantissa addition data IMM1_ADD<29:0>, and the third sign datum S3<0> as input data, thereby generating and outputting third exponent data E3<7:0> having 8 bits and third mantissa data M3<22:0> having 23 bits of the odd-numbered accumulated data D_ACC(ODD). The third sign datum S3<0> outputted from the mantissa operation circuit 220 and the third exponent data E3<7:0> and the third mantissa data M3<22:0> outputted from the normalizer 230 may be transmitted to the input terminal D of the left latch circuit 144(L), as described with reference to FIG. 7.

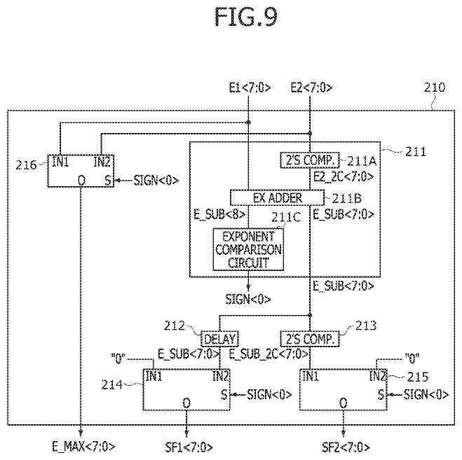

FIG. 9 is a block diagram illustrating an example of a configuration of the exponent operation circuit 210 included in the left accumulative adder 143(L) of FIG. 8. Referring to FIG. 9, the exponent operation circuit 210 may include an exponent subtraction circuit 211, a delay circuit 212, a 2's complement circuit 213, a first selector 214, a second selector 215, and a third selector 216. In an embodiment, each of the first to third selectors 214, 215, and 216 may include a 2-to-1 multiplexer. The exponent subtraction circuit 211 may include a 2's complement processor 211A, an exponent adder 2118, and an exponent comparison circuit 211C. In the present embodiment, the exponent adder 2118 may be comprised of an adder for adding integers.

The exponent subtraction circuit 211 may receive the first exponent data E1<7:0> of the odd-numbered multiplication/addition result data D_MA(ODD) and the second exponent data E2<7:0> of the left latched data D_LATCH(L). The exponent subtraction circuit 211 may generate 2's complement data of the second exponent data E2<7:0> in order to perform an arithmetic operation (E1<7:0>-E2<7:0>) for subtracting the second exponent data E2<7:0> from the first exponent data E1<7:0>. Thereafter, the exponent subtraction circuit 211 may add the 2's complement data of the second exponent data E2<7:0> to the first exponent data E1<7:0>. More specifically, the first exponent data E1<7:0> may be transmitted to a first input terminal of the exponent adder 211B, and the second exponent data E2<7:0> may be transmitted to the 2's complement processor 211A. The 2's complement processor 211A may calculate a 2's complement value of the second exponent data E2<7:0> to generate and output 2's complement data E2_2C<7:0> of the second exponent data E2<7:0>. The 2's complement data E2_2C<7:0> of the second exponent data E2<7:0> may be transmitted to a second input terminal of the exponent adder 211B.

The exponent adder 211B may add the 2's complement data E2_2C<7:0> of the second exponent data E2<7:0> to the first exponent data E1<7:0> to generate exponent subtraction data E_SUB<8:0> having 9 bits. The exponent adder 211B may separate the exponent subtraction data E_SUB<8:0> into two parts of a most significant bit (MSB) datum E_SUB<8> and 8-bit low-order data E_SUB<7:0> obtained by removing the MSB datum E_SUB<8> from the exponent subtraction data E_SUB<8:0>. The exponent adder 211B may transmit the MSB datum E_SUB<8> to the exponent comparison circuit 211C and may transmit the 8-bit low-order data E_SUB<7:0> to the delay circuit 212 and the 2's complement circuit 213.

The exponent comparison circuit 211C may compare a value of the first exponent data E1<7:0> with a value of the second exponent data E2<7:0> using the MSB datum E_SUB<8> outputted from the exponent adder 211B and may generate and output a sign signal SIGN<0> as the comparison result. Specifically, when a value of the first exponent data E1<7:0> is greater than a value of the second exponent data E2<7:0>, roundup may occur during the adding calculation of the exponent adder 211B. In such a case, the MSB datum E_SUB<8> may have a binary number of “1”. When the MSB datum E_SUB<8> has a binary number of “1”, the exponent comparison circuit 211C may output the sign signal SIGN<0> having a logic “low” level (e.g., a binary number of “0”) which denotes that the 8-bit low-order data E_SUB<7:0> are a positive number. In such a case, the second mantissa data M2<23:0> may be shifted by the number of bits corresponding to a difference value between absolute values of the first exponent data E1<7:0> and the second exponent data E2<7:0> such that the first exponent data E1<7:0> and the second exponent data E2<7:0> have the same absolute value. In contrast, when a value of the first exponent data E1<7:0> is less than a value of the second exponent data E2<7:0>, no roundup occurs during the adding calculation of the exponent adder 211B. In such a case, the MSB datum E_SUB<8> may have a binary number of “0”. When the MSB datum E_SUB<8> has a binary number of “0”, the exponent comparison circuit 211C may output the sign signal SIGN<0> having a logic “high” level (e.g., a binary number of “1”) which denotes that the 8-bit low-order data E_SUB<7:0> are a negative number. In such a case, the first mantissa data M1<28:0> may be shifted by the number of bits corresponding to a difference value between absolute values of the first exponent data E1<7:0> and the second exponent data E2<7:0> such that the first exponent data E1<7:0> and the second exponent data E2<7:0> have the same absolute value. The sign signal SIGN<0> outputted from the exponent comparison circuit 211C may be transmitted to selection terminals S of the first to third selectors 214, 215, and 216.

The delay circuit 212 may delay the 8-bit low-order data E_SUB<7:0>, which are outputted from the exponent adder 211B of the exponent subtraction circuit 211, by a certain delay time and may output the delayed data of the 8-bit low-order data E_SUB<7:0>. In an embodiment, the certain delay time may correspond to a period it takes the 2's complement circuit 213 to perform an arithmetic operation for calculating the 2's complement data of the 8-bit low-order data E_SUB<7:0>. The 8-bit low-order data E_SUB<7:0> outputted from the delay circuit 212 may be transmitted to a second input terminal IN2 of the first selector 214. The 2's complement circuit 213 may calculate a 2's complement value of the 8-bit low-order data E_SUB<7:0> outputted from the exponent adder 211B, thereby generating and outputting 2's complement data E_SUB_2C<7:0>. The 2's complement data E_SUB_2C<7:0> of the 8-bit low-order data E_SUB<7:0> may have an absolute value of a difference value between the first exponent data E1<7:0> and the second exponent data E2<7:0>. The 2's complement circuit 213 may transmit the 2's complement data E_SUB_2C<7:0> of the 8-bit low-order data E_SUB<7:0> to a first input terminal IN1 of the second selector 215.

The first selector 214 may receive a datum of “0” through a first input terminal IN1 of the first selector 214. In addition, the first selector 214 may receive the 8-bit low-order data E_SUB<7:0> from the delay circuit 212 through the second input terminal IN2 of the first selector 214. The second selector 215 may receive the 2's complement data E_SUB_2C<7:0> from the 2's complement circuit 213 through the first input terminal IN1 of the second selector 215. In addition, the second selector 215 may receive a datum of “0” through a second input terminal IN2 of the second selector 215. Each of the first and second selectors 214 and 215 may output one of two sets of input data according to the sign signal SIGN<0> inputted to the selection terminal S thereof. Hereinafter, data, which are outputted from the first selector 214 through an output terminal O of the first selector 214, will be referred to as the first shift data SF1<7:0>. In addition, data, which are outputted from the second selector 215 through an output terminal O of the second selector 215, will be referred to as the second shift data SF2<7:0>.

When the sign signal SIGN<0> has a datum of “0” (i.e., when the second mantissa data M2<23:0> has to be shifted), each of the first selector 214 and the second selector 215 may selectively output the data inputted through the first input terminal IN1. That is, the first selector 214 may selectively output the datum of “0” as the first shift data SF1<7:0> through the output terminal O of the first selector 214, and the second selector 215 may selectively output the 2's complement data E_SUB_2C<7:0> as the second shift data SF2<7:0> through the output terminal O of the second selector 215. When the sign signal SIGN<0> has a datum of “1” (i.e., when the first mantissa data M1<28:0> has to be shifted), each of the first selector 214 and the second selector 215 may selectively output the data inputted through the second input terminal IN2. That is, the first selector 214 may selectively output the 8-bit low-order data E_SUB<7:0> as the first shift data SF1<7:0> through the output terminal O of the first selector 214, and the second selector 215 may selectively output the datum of “0” as the second shift data SF2<7:0> through the output terminal O of the second selector 215. The first shift data SF1<7:0> and the second shift data SF2<7:0> outputted from respective ones of the first and second selectors 214 and 215 may be transmitted to the mantissa operation circuit 220.

The third selector 216 may receive the first exponent data E1<7:0> of the odd-numbered multiplication/addition result data D_MA(ODD) through a first input terminal IN1 of the third selector 216 and may also receive the second exponent data E2<7:0> of the left latched data D_LATCH(L) through a second input terminal IN2 of the third selector 216. The third selector 216 may selectively output one set of data having a larger value out of the first exponent data E1<7:0> and the second exponent data E2<7:0> through an output terminal O of the third selector 216 according to the sign signal SIGN<0> inputted through a selection terminal S of the third selector 216. Hereinafter, data, which are outputted from the third selector 216 through the output terminal O of the third selector 216, will be referred to as the maximum exponent data E_MAX<7:0>. When the sign signal SIGN<0> has a datum of “0” which denotes a positive number, it may correspond to a case that a value of the first exponent data E1<7:0> is greater than a value of the second exponent data E2<7:0>. In such a case, the third selector 216 may output the first exponent data E1<7:0> as the maximum exponent data E_MAX<7:0>. In contrast, when the sign signal SIGN<0> has a datum of “1” which denotes a negative number, it may correspond to a case that a value of the second exponent data E2<7:0> is greater than a value of the first exponent data E1<7:0>. In such a case, the third selector 216 may output the second exponent data E2<7:0> as the maximum exponent data E_MAX<7:0>. The third selector 216 may transmit the maximum exponent data E_MAX<7:0> to the normalizer 230.

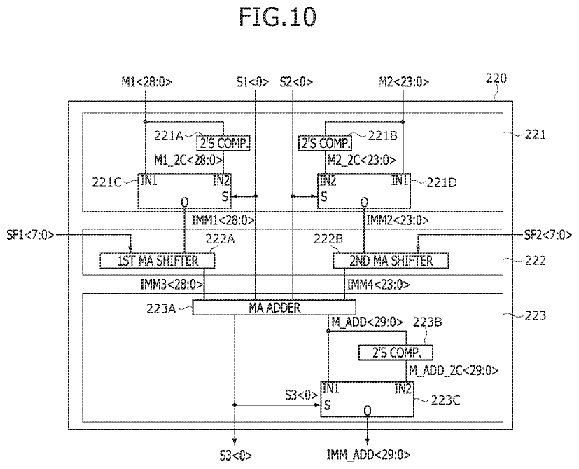

FIG. 10 is a block diagram illustrating an example of a configuration of the mantissa operation circuit 220 included in the left accumulative adder 143(L) of FIG. 8. Referring to FIG. 10, the mantissa operation circuit 220 may include a negative number processing circuit 221, a mantissa shift circuit 222, and a mantissa addition circuit 223. The negative number processing circuit 221 may include a first 2's complement circuit 221A, a second 2's complement circuit 221B, a first selector 221C, and a second selector 221D. The mantissa shift circuit 222 may include a first mantissa shifter 222A and a second mantissa shifter 222B. The mantissa addition circuit 223 may include a mantissa adder 223A, a third 2's complement circuit 223B, and a third selector 223C.

The first 2's complement circuit 221A of the negative number processing circuit 221 may receive the first mantissa data M1<28:0> of the odd-numbered multiplication/addition result data D_MA(ODD). The first 2's complement circuit 221A may calculate a 2's complement value of the first mantissa data M1<28:0> to generate and output 2's complement data M1_2C<28:0> of the first mantissa data M1<28:0>. The first selector 221C may receive the first mantissa data M1<28:0> of the odd-numbered multiplication/addition result data D_MA(ODD) through a first input terminal IN1 of the first selector 221C. The first selector 221C may also receive the 2's complement data M1_2C<28:0> from the first 2's complement circuit 221A through a second input terminal IN2 of the first selector 221C. In addition, the first selector 221C may receive the first sign datum S1<0> of the odd-numbered multiplication/addition result data D_MA(ODD) through a selection terminal S of the first selector 221C. When the first sign datum S1<0> has a binary number of “0” denoting a positive number, the first selector 221C may output the first mantissa data M1<28:0> inputted through the first input terminal IN1 through the output terminal O of the first selector 221C. In contrast, when the first sign datum S1<0> has a binary number of “1” denoting a negative number, the first selector 221C may output the 2's complement data M1_2C<28:0> inputted through the second input terminal IN2 through the output terminal O of the first selector 221C. Hereinafter, the output data of the first selector 221C will be referred to as first interim mantissa data IMM1<28:0>.

The second 2's complement circuit 221B of the negative number processing circuit 221 may receive the second mantissa data M2<23:0> of the left latched data D_LATCH(L). The second 2's complement circuit 221B may calculate a 2's complement value of the second mantissa data M2<23:0> to generate and output 2's complement data M2_2C<23:0> of the second mantissa data M2<23:0>. The second selector 221D may receive the second mantissa data M2<23:0> of the second mantissa data M2<23:0> of the left latched data D_LATCH(L) through a first input terminal IN1 of the second selector 221D. The first selector 221C may also receive the 2's complement data M2_2C<23:0> from the second 2's complement circuit 221B through a second input terminal IN2 of the second selector 221D. In addition, the second selector 221D may receive the second sign datum S2<0> of the left latched data D_LATCH(L) through a selection terminal S of the second selector 221D. When the second sign datum S2<0> has a binary number of “0” denoting a positive number, the second selector 221D may output the second mantissa data M2<23:0> inputted through the first input terminal IN1 through the output terminal O of the second selector 221D. In contrast, when the second sign datum S2<0> has a binary number of “1” denoting a negative number, the second selector 221D may output the 2's complement data M2_2C<23:0> inputted through the second input terminal IN2 through the output terminal O of the second selector 221D. Hereinafter, the output data of the second selector 221D will be referred to as second interim mantissa data IMM2<23:0>.

The first mantissa shifter 222A of the mantissa shift circuit 222 may receive the first interim mantissa data IMM1<28:0> from the first selector 221C of the negative number processing circuit 221. In addition, the first mantissa shifter 222A may receive the first shift data SF1<7:0> from the first selector 214 of the exponent operation circuit 210. The first mantissa shifter 222A may shift the first interim mantissa data IMM1<28:0> by the number of bits corresponding to an absolute value of the first shift data SF1<7:0> to output the shifted data of the first interim mantissa data IMM1<28:0>. Hereinafter, the output data of the first mantissa shifter 222A will be referred to as third interim mantissa data IMM3<28:0>. When the first shift data SF1<7:0> have a value of “0”, the third interim mantissa data IMM3<28:0> may be equal to the first interim mantissa data IMM1<28:0>. In contrast, when the first shift data SF1<7:0> are the 8-bit low-order data E_SUB<7:0> of the exponent subtraction data E_SUB<8:0>, the third interim mantissa data IMM3<28:0> may be generated by shifting the first interim mantissa data IMM1<28:0> by the number of bits corresponding to an absolute value of the 8-bit low-order data E_SUB<7:0> of the exponent subtraction data E_SUB<8:0>. The third interim mantissa data IMM3<28:0> outputted from the first mantissa shifter 222A may be transmitted to the mantissa addition circuit 223.

The second mantissa shifter 222B of the mantissa shift circuit 222 may receive the second interim mantissa data IMM2<23:0> from the second selector 221D of the negative number processing circuit 221. In addition, the second mantissa shifter 222B may receive the second shift data SF2<7:0> from the second selector 215 of the exponent operation circuit 210. The second mantissa shifter 222B may shift the second interim mantissa data IMM2<23:0> by the number of bits corresponding to an absolute value of the second shift data SF2<7:0> to output the shifted data of the second interim mantissa data IMM2<23:0>. Hereinafter, the output data of the second mantissa shifter 222B will be referred to as fourth interim mantissa data IMM4<23:0>. When the second shift data SF2<7:0> have a value of “0”, the fourth interim mantissa data IMM4<23:0> may be equal to the second interim mantissa data IMM2<23:0>. In contrast, when the second shift data SF2<7:0> are the 2's complement data E_SUB_2C<7:0> of the 8-bit low-order data E_SUB<7:0>, the fourth interim mantissa data IMM4<23:0> may be generated by shifting the second interim mantissa data IMM2<23:0> by the number of bits corresponding to an absolute value of the 2's complement data E_SUB_2C<7:0> of the 8-bit low-order data E_SUB<7:0>. The fourth interim mantissa data IMM4<23:0> outputted from the second mantissa shifter 222B may be transmitted to the mantissa addition circuit 223.

The mantissa adder 223A of the mantissa addition circuit 223 may receive the third interim mantissa data IMM3<28:0> from the first mantissa shifter 222A of the mantissa shift circuit 222 and may also receive the fourth interim mantissa data IMM4<23:0> from the second mantissa shifter 222B of the mantissa shift circuit 222. In addition, the mantissa adder 223A may receive the first sign datum S1<0> and the second sign datum S2<0>. The mantissa adder 223A may generate and output a third sign datum S3<0>. In addition, the mantissa adder 223A may add the third interim mantissa data IMM3<28:0> to the fourth interim mantissa data IMM4<23:0> to generate and output mantissa addition data M_ADD<29:0>. When both of the first sign datum S1<0> and the second sign datum S2<0> have a binary number of “0” denoting a positive number, the mantissa adder 223A may output a binary number of “0” as the third sign datum S3<0>. When both of the first sign datum S1<0> and the second sign datum S2<0> have a binary number of “1” denoting a negative number, the mantissa adder 223A may output a binary number of “1” as the third sign datum S3<0>. When one of the first and second sign data S1<0> and S2<0> has a binary number of “0” and the other has a binary number of “1”, the mantissa adder 223A may output a binary number of “0” as the third sign datum S3<0> if roundup occurs during the adding calculation on the third and fourth interim mantissa data IMM3<28:0> and IMM4<23:0> and may output a binary number of “1” as the third sign datum S3<0> if no roundup occurs during the adding calculation on the third and fourth interim mantissa data IMM3<28:0> and IMM4<23:0>. The third sign datum S3<0> outputted from the mantissa adder 223A may correspond to a sign datum of the odd-numbered accumulated data D_ACC(ODD). The third sign datum S3<0> outputted from the mantissa adder 223A may also be transmitted to a selection terminal S of the third selector 223C. The mantissa addition data M_ADD<29:0> outputted from the mantissa adder 223A may be transmitted to the third 2's complement circuit 223B and the third selector 223C.

The third 2's complement circuit 223B of the mantissa addition circuit 223 may receive the mantissa addition data M_ADD<29:0> from the mantissa adder 223A. The third 2's complement circuit 223B may calculate a 2's complement value of the mantissa addition data M_ADD<29:0> to generate and output 2's complement data M_ADD_2C<29:0> of the mantissa addition data M_ADD<29:0>. The third selector 223C may receive the mantissa addition data M_ADD<29:0> from the mantissa adder 223A through a first input terminal IN1 of the third selector 223C and may also receive the 2's complement data M_ADD_2C<29:0> from the third 2's complement circuit 223B through a second input terminal IN2 of the third selector 223C. In addition, the third selector 223C may receive the third sign datum S3<0> from the mantissa adder 223A through a selection terminal S of the third selector 223C. When the third sign datum S3<0> has a binary number of “0” denoting a positive number, the third selector 223C may output the mantissa addition data M_ADD<29:0> through an output terminal O of the third selector 223C. In contrast, when the third sign datum S3<0> has a binary number of “1” denoting a negative number, the third selector 223C may output the 2's complement data M_ADD_2C<29:0> through the output terminal O of the third selector 223C. hereinafter, the output data of the third selector 223C will be referred to as interim mantissa addition data IMM_ADD<29:0>.

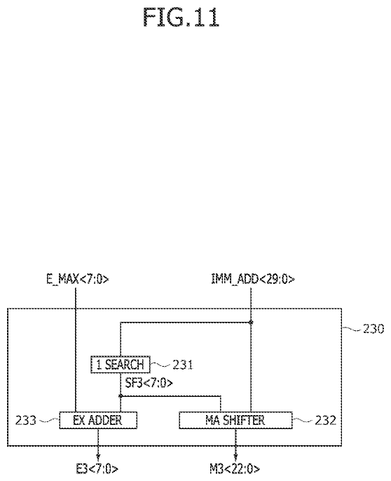

FIG. 11 is a block diagram illustrating an example of a configuration of the normalizer 230 included in the left accumulative adder 143(L) of FIG. 8. Referring to FIG. 11, the normalizer 230 may include a “1” search circuit 231, a mantissa shifter 232, and an exponent adder 233. The “1” search circuit 231 of the normalizer 230 may receive the interim mantissa addition data IMM_ADD<29:0> from the third selector (223C of FIG. 10) of the mantissa addition circuit (223 of FIG. 10). The “1” search circuit 231 may search a position where a binary number of “1” is first located in a right direction from a leftmost bit of the interim mantissa addition data IMM_ADD<29:0> and may generate third shift data SF3<7:0> as the search result. The third shift data SF3<7:0> may have a value corresponding to the number of bits for shifting the interim mantissa addition data IMM_ADD<29:0> such that the interim mantissa addition data IMM_ADD<29:0> have a standard form of “1.mantissa”. In an embodiment, the number of bits included in the third shift data may be arbitrarily set. In the present embodiment, it may be assumed that the third shift data SF3<7:0> are set to have 8 bits. The third shift data SF3<7:0> outputted from the “1” search circuit 231 may be transmitted to the mantissa shifter 232 and the exponent adder 233.

The mantissa shifter 232 of the normalizer 230 may perform a shifting operation on the interim mantissa addition data IMM_ADD<29:0> such that the interim mantissa addition data IMM_ADD<29:0> have a standard form of “1.mantissa”. The mantissa shifter 232 may receive the third shift data SF3<7:0> from the “1” search circuit 231 and may also receive the interim mantissa addition data IMM_ADD<29:0> from the third selector (223C of FIG. 10) of the mantissa addition circuit (223 of FIG. 10). The mantissa shifter 232 may shift the interim mantissa addition data IMM_ADD<29:0> by the number of bits corresponding to a value of the third shift data SF3<7:0>, thereby generating the third mantissa data M3<22:0> of the odd-numbered accumulated data D_ACC(ODD) outputted from the left accumulative adder 143(L). Although not illustrated in FIG. 11, a rounding process may be performed during the shifting operation of the mantissa shifter 232.

The exponent adder 233 of the normalizer 230 may change a value of the maximum exponent data E_MAX<7:0> to compensate for variation of the interim mantissa addition data IMM_ADD<29:0> which is due to the shifting operation for shifting the interim mantissa addition data IMM_ADD<29:0> by the number of bits corresponding to a value of the third shift data SF3<7:0>. The exponent adder 233 may receive the maximum exponent data E_MAX<7:0> from the third selector (216 of FIG. 9) of the exponent operation circuit (210 of FIG. 9) and may also receive the third shift data SF3<7:0> from the “1” search circuit 231. The exponent adder 233 may perform an adding calculation on the maximum exponent data E_MAX<7:0> and the third shift data SF3<7:0> to generate the third exponent data E3<7:0> of the odd-numbered accumulated data D_ACC(ODD) outputted from the left accumulative adder 143(L).

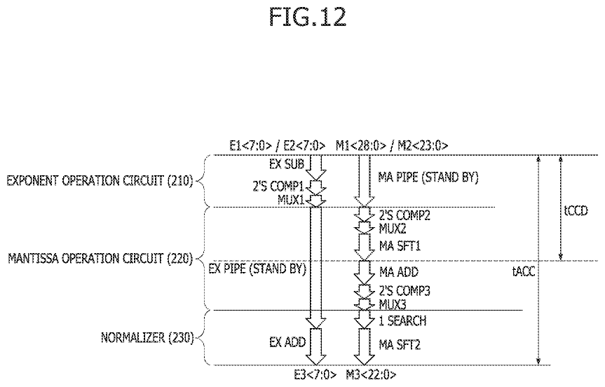

FIG. 12 illustrates an operation of processing the exponent data and the mantissa data during an accumulative adding calculation of the left accumulative adder 143(L) described with reference to FIGS. 8 to 11. Referring to FIGS. 8 to 11 and 12, the exponent operation circuit 210 may sequentially perform an exponent subtraction operation EX_SUB on the first exponent data E1<7:0> and the second exponent data E2<7:0>, a first 2's complement calculation operation 2'S_COMP1, and a first selection operation MUX1. As described with reference to FIG. 9, the exponent subtraction operation EX_SUB may correspond to an operation which is performed by the exponent subtraction circuit 211 to generate the sign signal SIGN<0> and the 8-bit low-order data E_SUB<7:0> of the exponent subtraction data E_SUB<8:0>. The first 2's complement calculation operation 2'S_COMP1 may correspond to an operation which is performed by the 2's complement circuit 213 calculating a 2's complement value of the 8-bit low-order data E_SUB<7:0> to generate the 2's complement data E_SUB_2C<7:0>. The first selection operation MUX1 may correspond to an operation which is performed by the first and second selectors 214 and 215 to generate the first shift data SF1<7:0> and the second shift data SF2<7:0>. While the operations of the exponent operation circuit 210 are performed, the first mantissa data M1<28:0> and the second mantissa data M2<23:0> may be on standby in a mantissa pipe MA_PIPE.

After all of the operations of the exponent operation circuit 210 terminate, the mantissa operation circuit 220 may sequentially perform a second 2's complement calculation operation 2'S_COMP2 on the first mantissa data M1<28:0> and the second mantissa data M2<23:0>, a second selection operation MUX2, a first mantissa shift operation MA_SFT1, a mantissa addition operation MA_ADD, a third 2's complement calculation operation 2'S_COMP3, and a third selection operation MUX3. As described with reference to FIG. 10, the second 2's complement calculation operation 2'S_COMP2 may correspond to an operation which is performed by the first and second 2's complement circuits 221A and 221B of the negative number processing circuit 221 to generate the 2's complement data M1_2C<28:0> of the first mantissa data M1<28:0> and the 2's complement data M2_2C<23:0> of the second mantissa data M2<23:0>. The second selection operation MUX2 may correspond to an operation which is performed by the first and second selectors 221C and 221D of the negative number processing circuit 221 to generate the first interim mantissa data IMM1<28:0> and the second interim mantissa data IMM2<23:0>. The first mantissa shift operation MA_SFT1 may correspond to an operation which is performed by the first and second mantissa shifters 222A and 222B of the mantissa shift circuit 222 to generate the third interim mantissa data IMM3<28:0> and the fourth interim mantissa data IMM4<23:0>. The mantissa addition operation MA_ADD may correspond to an operation which is performed by the mantissa adder 223A of the mantissa addition circuit 223 to generate the third sign datum S3<0> and the mantissa addition data M_ADD<29:0>. The third 2's complement calculation operation 2'S_COMP3 may correspond to an operation which is performed by the third 2's complement circuit 2238 of the mantissa addition circuit 223 to generate the 2's complement data M_ADD_2C<29:0> of the mantissa addition data M_ADD<29:0>. The third selection operation MUX3 may correspond to an operation which is performed by the third selector 223C of the mantissa addition circuit 223 to generate the interim mantissa addition data IMM_ADD<29:0>. While the operations of the mantissa operation circuit 220 are performed, no exponent processing operation is performed and the maximum exponent data E_MAX<7:0> generated by the exponent operation circuit (210 of FIG. 8) may be on standby in an exponent pipe EX_PIPE.

After all of the operations of the mantissa operation circuit 220 terminate, the normalizer 230 may sequentially perform a “1” searching operation 1_SEARCH, an exponent addition operation EX_ADD, and a second mantissa shift operation MA_SFT2. As described with reference to FIG. 11, the “1” searching operation 1_SEARCH may correspond to an operation which is performed by the “1” search circuit 231 of the normalizer 230 to generate the third shift data SF3<7:0>. The exponent addition operation EX_ADD may correspond to an operation which is performed by the exponent adder 233 of the normalizer 230 to generate the third exponent data E3<7:0> of the odd-numbered accumulated data D_ACC(ODD). The second mantissa shift operation MA_SFT2 may correspond to an operation which is performed by the mantissa shifter 232 of the normalizer 230 to generate the third mantissa data M3<22:0> of the odd-numbered accumulated data D_ACC(ODD). The exponent addition operation EX_ADD and the second mantissa shift operation MA_SFT2 may be performed independently. Meanwhile, the maximum exponent data E_MAX<7:0> generated by the exponent operation circuit (210 of FIG. 8) may be on standby in the exponent pipe EX_PIPE until the “1” searching operation 1_SEARCH terminates.

As described above, while the exponent data are processed by the exponent operation circuit 210, the mantissa data may be on standby. In contrast, while the mantissa data are processed by the mantissa operation circuit 220, the exponent data may be on standby. The exponent data may be on standby until the normalizer 230 terminates the “1” searching operation 1_SEARCH. The exponent addition operation EX_ADD and the second mantissa shift operation MA_SFT2 may be performed independently. A time (i.e., an accumulative addition time “tACC”) it takes the left accumulative adder (143(L) of FIG. 7) of the left accumulator (140(L) of FIG. 7) to generate and output the odd-numbered accumulated data D_ACC(ODD) using the odd-numbered multiplication/addition result data D_MA(ODD) and the left latched data D_LATCH(L) as input data may correspond to a time it takes to perform all of the operations of the exponent operation circuit 210, the mantissa operation circuit 220, and the normalizer 230. That is, after the accumulative addition time “tACC” elapses from a point in time when the odd-numbered multiplication/addition result data D_MA(ODD) and the left latched data D_LATCH(L) are inputted to the left accumulative adder 143(L), the odd-numbered accumulated data D_ACC(ODD) may be outputted from the left accumulative adder 143(L). The odd-numbered accumulated data D_ACC(ODD) may be used as the left latched data D_LATCH(L) which are accumulatively added to the odd-numbered multiplication/addition result data D_MA(ODD) inputted to the left accumulative adder 143(L) in a next step. This means that the left latched data D_LATCH(L) are able to be inputted to the left accumulative adder 143(L) at an interval time of the accumulative addition time “tACC”. In contrast, the odd-numbered multiplication/addition result data D_MA(ODD) may be inputted to the left accumulative adder 143(L) at an interval time of the CAS to CAS delay time “tCCD”. That is, in the event that the odd-numbered multiplication/addition result data D_MA(ODD) are inputted to the left accumulative adder 143(L) at an interval time of the CAS to CAS delay time “tCCD”, the left latched data D_LATCH(L) cannot be inputted to the left accumulative adder 143(L) with the odd-numbered multiplication/addition result data D_MA(ODD) due to a previous accumulative adding calculation which has not terminated yet. Thus, the AI accelerator 100 according to the present embodiment may be configured such that each of the left accumulative adder 143(L) and the right accumulative adder 143(R) receives the multiplication/addition result data at an interval time of twice the CAS to CAS delay time “tCCD”. In such a case, if the accumulative addition time “tACC” is not longer than twice the CAS to CAS delay time “tCCD”, the multiplication/addition result data and the latched data may be inputted to each of the left accumulative adder 143(L) and the right accumulative adder 143(R) together.

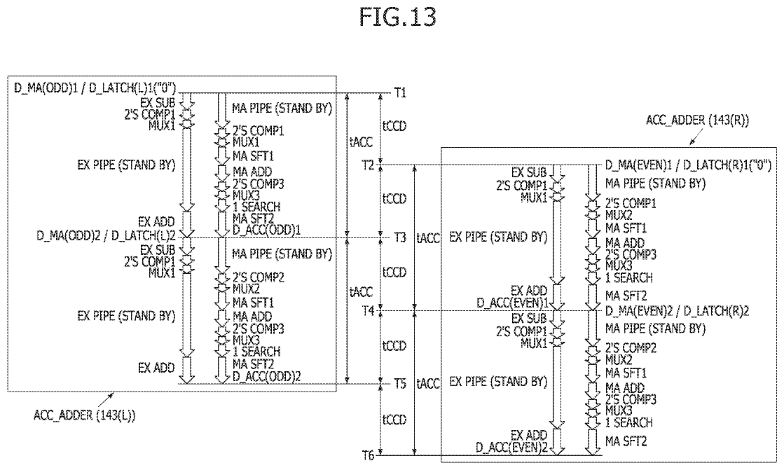

FIG. 13 illustrates operation timings of the left accumulative adder 143(L) and the right accumulative adder 143(R) shown in FIG. 7. In the present embodiment, it may be assumed that the accumulative addition time “tACC” is set to be twice the CAS to CAS delay time “tCCD” (i.e., “2×tCCD”) which corresponds to a maximum value. Referring to FIGS. 7 and 13, the left accumulative adder 143(L) may receive first odd-numbered multiplication/addition result data D_MA(ODD)1 and first left latched data D_LATCH(L)1 at a first point in time “T1”. The first odd-numbered multiplication/addition result data D_MA(ODD)1 may correspond to first multiplication/addition result data outputted from the multiplication circuit/adder tree (130 of FIG. 1). The first point in time “T1” may be a moment when a first pulse of the odd clock signal CK_ODD occurs, as described with reference to FIG. 2. The left latch circuit 144(L) may have a reset state at the first point in time “T1” because the present accumulative adding calculation is a first accumulative adding calculation of the left accumulator 140(L). Thus, the first left latched data D_LATCH(L)1 having a reset value of “0” may be inputted to the left accumulative adder 143(L). At the first point in time “T1”, the left accumulative adder 143(L) may commence to perform an accumulative adding calculation on the first odd-numbered multiplication/addition result data D_MA(ODD)1 and the first left latched data D_LATCH(L)1. At a third point in time “T3” when the accumulative addition time “tACC” (i.e., “2×tCCD”) elapses from the first point in time “T1”, the left accumulative adder 143(L) may output first odd-numbered accumulated data D_ACC(ODD)1. The first odd-numbered accumulated data D_ACC(ODD)1 may be used as second left latched data D_LATCH(L)2 during a next accumulative adding calculation of the left accumulative adder 143(L).

At a second point in time “T2” when the CAS to CAS delay time “tCCD” elapses from the first point in time “T1”, the right accumulative adder 143(R) may receive first even-numbered multiplication/addition result data D_MA(EVEN)1 and first right latched data D_LATCH(R)1. The first even-numbered multiplication/addition result data D_MA(EVEN)1 may correspond to second multiplication/addition result data outputted from the multiplication circuit/adder tree (130 of FIG. 1). The second point in time “T2” may be a moment when a first pulse of the even clock signal CK_EVEN occurs, as described with reference to FIG. 2. The right latch circuit 144(R) may have a reset state at the second point in time “T2” because the present accumulative adding calculation is a first accumulative adding calculation of the right accumulator 140(R). Thus, the first right latched data D_LATCH(R)1 having a reset value of “0” may be inputted to the right accumulative adder 143(R). At the second point in time “T2”, the right accumulative adder 143(R) may commence to perform an accumulative adding calculation on the first even-numbered multiplication/addition result data D_MA(EVEN)1 and the first right latched data D_LATCH(R)1. At a fourth point in time “T4” when the accumulative addition time “tACC” (i.e., “2×tCCD”) elapses from the second point in time “T2”, the right accumulative adder 143(R) may output first even-numbered accumulated data D_ACC(EVEN)1. The first even-numbered accumulated data D_ACC(EVEN)1 may be used as second right latched data D_LATCH(R)2 during a next accumulative adding calculation of the right accumulative adder 143(R).

At the third point in time “T3” when the CAS to CAS delay time “tCCD” elapses from the second point in time “T2”, the left accumulative adder 143(L) may receive second odd-numbered multiplication/addition result data D_MA(ODD)2 and the second left latched data D_LATCH(L)2. The second odd-numbered multiplication/addition result data D_MA(ODD)2 may correspond to third multiplication/addition result data outputted from the multiplication circuit/adder tree (130 of FIG. 1). The third point in time “T3” may be a moment when a second pulse of the odd clock signal CK_ODD occurs, as described with reference to FIG. 2. Because the first odd-numbered accumulated data D_ACC(ODD)1 are latched in the left latch circuit 144(L) by a previous step, the first odd-numbered accumulated data D_ACC(ODD)1 corresponding to the second left latched data D_LATCH(L)2 may be inputted to the left accumulative adder 143(L). At the third point in time “T3”, the left accumulative adder 143(L) may commence to perform an accumulative adding calculation on the second odd-numbered multiplication/addition result data D_MA(ODD)2 and the second left latched data D_LATCH(L)2. At a fifth point in time “T5” when the accumulative addition time “tACC” (i.e., “2×tCCD”) elapses from the third point in time “T3”, the left accumulative adder 143(L) may output second odd-numbered accumulated data D_ACC(ODD)2. The second odd-numbered accumulated data D_ACC(ODD)2 may be used as third left latched data (not shown) during a next accumulative adding calculation of the left accumulative adder 143(L).

At the fourth point in time “T4” when the CAS to CAS delay time “tCCD” elapses from the third point in time “T3”, the right accumulative adder 143(R) may receive second even-numbered multiplication/addition result data D_MA(EVEN)2 and the second right latched data D_LATCH(R)2. The second even-numbered multiplication/addition result data D_MA(EVEN)2 may correspond to fourth multiplication/addition result data outputted from the multiplication circuit/adder tree (130 of FIG. 1). The fourth point in time “T4” may be a moment when a second pulse of the even clock signal CK_EVEN occurs, as described with reference to FIG. 2. Because the first even-numbered accumulated data D_ACC(EVEN)1 are latched in the right latch circuit 144(R) by a previous step, the first even-numbered accumulated data D_ACC(EVEN)1 corresponding to the second right latched data D_LATCH(R)2 may be inputted to the right accumulative adder 143(R). At the fourth point in time “T4”, the right accumulative adder 143(R) may commence to perform an accumulative adding calculation on the second even-numbered multiplication/addition result data D_MA(EVEN)2 and the second right latched data D_LATCH(R)2. At a sixth point in time “T6” when the accumulative addition time “tACC” (i.e., “2×tCCD”) elapses from the fourth point in time “T4”, the right accumulative adder 143(R) may output second even-numbered accumulated data D_ACC(EVEN)2. The second even-numbered accumulated data D_ACC(EVEN)2 may be used as third right latched data (not shown) during a next accumulative adding calculation of the right accumulative adder 143(R).

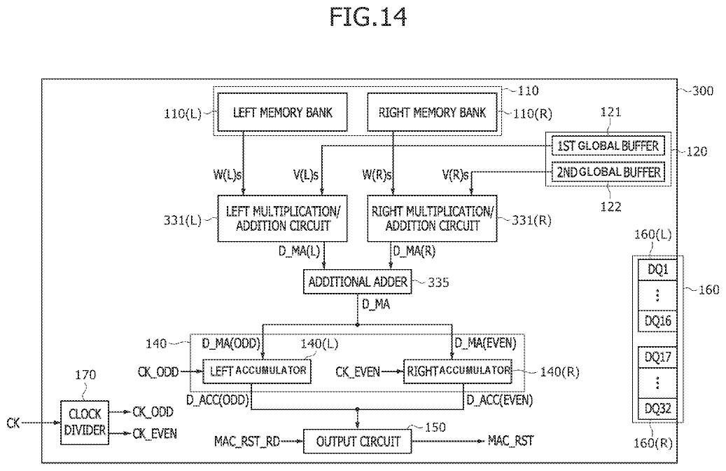

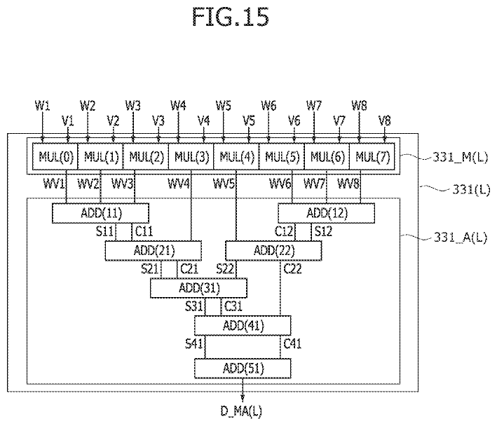

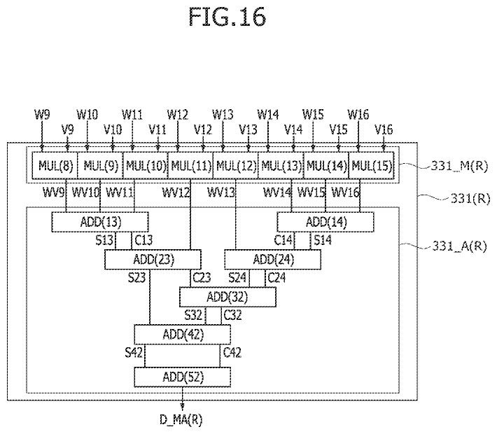

FIG. 14 is a block diagram illustrating an AI accelerator 300 according to another embodiment of the present disclosure. FIGS. 15 and 16 are block diagrams illustrating configurations of a left multiplication/addition circuit 331(L) and a right multiplication/addition circuit 331(R) included in the AI accelerator 300 of FIG. 14, respectively. In FIG. 14, the same reference numerals or symbols as used in FIG. 1 may denote the same elements. Thus, descriptions of the same elements as set forth in the embodiment of FIG. 1 will be omitted in the present embodiment. First, referring to FIG. 14, the AI accelerator 300 may include the first memory circuit 110, the second memory circuit 120, the left multiplication/addition circuit 331(L), the right multiplication/addition circuit 331(R), an additional adder 335, the accumulative addition circuit 140, the output circuit 150, the data I/O circuit 160, and the clock divider 170. The AI accelerator 300 may be different from the AI accelerator 100 described with reference to FIG. 1 in terms of a point that the AI accelerator 300 includes the left multiplication/addition circuit 331(L), the right multiplication/addition circuit 331(R), and the additional adder 335.

Specifically, the left multiplication/addition circuit 331(L) may include a left multiplication circuit 331_M(L) and a left adder tree 331_A(L), as illustrated in FIG. 15. The left multiplication circuit 331_M(L) may include a plurality of multipliers, for example, first to eighth multipliers MUL(0)˜MUL(7). The first to eighth multipliers MUL(0)˜MUL(7) may receive first to eighth weight data W1˜W8 from a left memory bank 110(L) of the first memory circuit 110, respectively. In addition, the first to eighth multipliers MUL(0)˜MUL(7) may receive first to eighth vector data V1˜V8 from a first global buffer 121 of the second memory circuit 120, respectively. The first to eighth weight data W1˜W8 may constitute the left weight data W(L)s described with reference to FIG. 1, and the first to eighth vector data V1˜V8 may constitute the left vector data V(L)s described with reference to FIG. 1. The first to eighth multipliers MUL(0)˜MUL(7) may perform multiplying calculations on the first to eighth weight data W1˜W8 and the first to eighth vector data V1˜V8 to generate first to eighth multiplication result data WV1˜WV8, respectively. The first to eighth multiplication result data WV1˜WV8 may be transmitted to the left adder tree 331_A(L).

The left adder tree 331_A(L) may perform an adding calculation on the first to eighth multiplication result data WV1˜WV8 outputted from the left multiplication circuit 331_M(L). The left adder tree 331_A(L) may generate and output left multiplication/addition result data D_MA(L) as a result of the adding calculation. The left adder tree 331_A(L) may include a plurality of adders ADDs which are arrayed to have a hierarchical structure such as a tree structure. In the present embodiment, the left adder tree 331_A(L) may be comprised of a plurality of full-adders and a half-adder. However, the present embodiment is merely an example of the present disclosure. Accordingly, in some other embodiment, the left adder tree 331_A(L) may be comprised of only a plurality of half-adders. In the present embodiment, two full-adders ADD(11) and ADD(12) may be disposed in a first stage located at a highest level of the left adder tree 331_A(L), and two full-adders ADD(21) and ADD(22) may also be disposed in a second stage located at a second highest level of the left adder tree 331_A(L). In addition, one full-adder ADD(31) may be disposed in a third stage located at a third highest level of the left adder tree 331_A(L), and one full-adder ADD(41) may also be disposed in a fourth stage located at a fourth highest level of the left adder tree 331_A(L). Moreover, one half-adder ADD(51) may be disposed in a fifth stage located at a lowest level of the left adder tree 331_A(L).

The first full-adder ADD(11) in the first stage may perform an adding calculation on the first to third multiplication result data WV1˜WV3 outputted from the first to third multipliers MUL(0)˜MUL(2) of the left multiplication circuit 331_M(L), thereby generating and outputting added data S11 and a carry C11. The second full-adder ADD(12) in the first stage may perform an adding calculation on the sixth to eighth multiplication result data WV6˜WV8 outputted from the sixth to eighth multipliers MUL(5)˜MUL(7) of the left multiplication circuit 331_M(L), thereby generating and outputting added data S12 and a carry C12. The first full-adder ADD(21) in the second stage may perform an adding calculation on the added data S11 and the carry C11 outputted from the first full-adder ADD(11) in the first stage and the fourth multiplication result data WV4 outputted from the fourth multiplier MUL(3) of the left multiplication circuit 331_M(L), thereby generating and outputting added data S21 and a carry C21. The second full-adder ADD(22) in the second stage may perform an adding calculation on the added data S12 and the carry C12 outputted from the second full-adder ADD(12) in the first stage and the fifth multiplication result data WV5 outputted from the fifth multiplier MUL(4) of the left multiplication circuit 331_M(L), thereby generating and outputting added data S22 and a carry C22.

The full-adder ADD(31) in the third stage may perform an adding calculation on the added data S21 and the carry C21 outputted from the first full-adder ADD(21) in the second stage and the added data S22 outputted from the second full-adder ADD(22) in the second stage, thereby generating and outputting added data S31 and a carry C31. The full-adder ADD(41) in the fourth stage may perform an adding calculation on the added data S31 and the carry C31 outputted from the full-adder ADD(31) in the third stage and the carry C(22) outputted from the second full-adder ADD(22) in the second stage, thereby generating and outputting added data S41 and a carry C41. The half-adder ADD(51) in the fifth stage may perform an adding calculation on the added data S41 and the carry C41 outputted from the full-adder ADD(41) in the fourth stage, thereby generating and outputting the left multiplication/addition result data D_MA(L). The left multiplication/addition result data D_MA(L) outputted from the half-adder ADD(51) in the fifth stage of the left multiplication circuit 331_M(L) may be transmitted to the additional adder 335.

The right multiplication/addition circuit 331(R) may include a right multiplication circuit 331_M(R) and a right adder tree 331_A(R), as illustrated in FIG. 16. The right multiplication circuit 331_M(R) may include a plurality of multipliers, for example, ninth to sixteenth multipliers MUL(8)˜MUL(15). The ninth to sixteenth multipliers MUL(8)˜MUL(15) may receive ninth to sixteenth weight data W9˜W16 from a right memory bank 110(R) of the first memory circuit 110, respectively. In addition, the ninth to sixteenth multipliers MUL(8)˜MUL(15) may receive ninth to sixteenth vector data V9˜V16 from a second global buffer 122 of the second memory circuit 120, respectively. The ninth to sixteenth weight data W9˜W16 may constitute the right weight data W(R)s described with reference to FIG. 1, and the ninth to sixteenth vector data V9˜V16 may constitute the right vector data V(R)s described with reference to FIG. 1. The ninth to sixteenth multipliers MUL(8)˜MUL(15) of the right multiplication circuit 331_M(R) may perform multiplying calculations on the ninth to sixteenth weight data W9˜W16 and the ninth to sixteenth vector data V9˜V16 to generate ninth to sixteenth multiplication result data WV9˜WV16, respectively. The ninth to sixteenth multiplication result data WV9˜WV16 may be transmitted to the right adder tree 331_A(R).

The right adder tree 331_A(R) may perform an adding calculation on the ninth to sixteenth multiplication result data WV9˜WV16 outputted from the right multiplication circuit 331_M(R). The right adder tree 331_A(R) may generate and output right multiplication/addition result data D_MA(R) as a result of the adding calculation. The right adder tree 331_A(R) may include a plurality of adders ADDs which are arrayed to have a hierarchical structure such as a tree structure. In the present embodiment, the right adder tree 331_A(R) may be comprised of a plurality of full-adders and a half-adder. However, the present embodiment is merely an example of the present disclosure. Accordingly, in some other embodiment, the right adder tree 331_A(R) may be comprised of only a plurality of half-adders. In the present embodiment, two full-adders ADD(13) and ADD(14) may be disposed in a first stage located at a highest level of the right adder tree 331_A(R), and two full-adders ADD(23) and ADD(24) may also be disposed in a second stage located at a second highest level of the right adder tree 331_A(R). In addition, one full-adder ADD(32) may be disposed in a third stage located at a third highest level of the right adder tree 331_A(R), and one full-adder ADD(42) may also be disposed in a fourth stage located at a fourth highest level of the right adder tree 331_A(R). Moreover, one half-adder ADD(52) may be disposed in a fifth stage located at a lowest level of the right adder tree 331_A(R).

The first full-adder ADD(13) in the first stage may perform an adding calculation on the ninth to eleventh multiplication result data WV9˜WV11 outputted from the ninth to eleventh multipliers MUL(8)˜MUL(10) of the right multiplication circuit 331_M(R), thereby generating and outputting added data S13 and a carry C13. The second full-adder ADD(14) in the first stage may perform an adding calculation on the fourteenth to sixteenth multiplication result data WV14˜WV16 outputted from the fourteenth to sixteenth multipliers MUL(13)˜MUL(15) of the right multiplication circuit 331_M(R), thereby generating and outputting added data S14 and a carry C14. The first full-adder ADD(23) in the second stage may perform an adding calculation on the added data S13 and the carry C13 outputted from the first full-adder ADD(13) in the first stage and the twelfth multiplication result data WV12 outputted from the twelfth multiplier MUL(11) of the right multiplication circuit 331_M(R), thereby generating and outputting added data S23 and a carry C23. The second full-adder ADD(24) in the second stage may perform an adding calculation on the added data S14 and the carry C14 outputted from the second full-adder ADD(14) in the first stage and the thirteenth multiplication result data WV13 outputted from the thirteenth multiplier MUL(12) of the right multiplication circuit 331_M(R), thereby generating and outputting added data S24 and a carry C24.

The full-adder ADD(32) in the third stage may perform an adding calculation on the carry 23 outputted from the first full-adder ADD(23) in the second stage and the added data S24 and the carry C24 outputted from the second full-adder ADD(24) in the second stage, thereby generating and outputting added data S32 and a carry C32. The full-adder ADD(42) in the fourth stage may perform an adding calculation on the added data S32 and the carry C32 outputted from the full-adder ADD(32) in the third stage and the added data S(23) outputted from the first full-adder ADD(23) in the second stage, thereby generating and outputting added data S42 and a carry C42. The half-adder ADD(52) in the fifth stage may perform an adding calculation on the added data S42 and the carry C42 outputted from the full-adder ADD(42) in the fourth stage, thereby generating and outputting the right multiplication/addition result data D_MA(R). The right multiplication/addition result data D_MA(R) outputted from the half-adder ADD(52) in the fifth stage of the right multiplication circuit 331_M(R) may be transmitted to the additional adder 335.

Referring again to FIG. 14, the first accumulative addition time “tACC1” it takes the left accumulator 140(L) of the AI accelerator 300 to perform the accumulative adding calculation may be longer than the CAS to CAS delay time “tCCD” and may be shorter than twice the CAS to CAS delay time “tCCD”, like the AI accelerator 100 described with reference to FIG. 1. Similarly, the second accumulative addition time “tACC2” it takes the right accumulator 140(R) of the AI accelerator 300 to perform the accumulative adding calculation may also be longer than the CAS to CAS delay time “tCCD” and may be shorter than twice the CAS to CAS delay time “tCCD”. As such, the left accumulator 140(L) and the right accumulator 140(R) may perform an accumulative adding calculation within the first accumulative addition time “tACC1” and the second accumulative addition time “tACC2”, which are shorter than twice the CAS to CAS delay time “tCCD”, respectively. Thus, it may be unnecessary to adjust the CAS to CAS delay time “tCCD” during the MAC operation. In addition, in the event that each memory bank is divided into the left memory bank 110(L) and the right memory bank 110(R), the left accumulator 140(L) may be realized using an accumulator included in a left MAC operator and the right accumulator 140(R) may be realized using an accumulator included in a right MAC operator. Thus, it may be unnecessary to additionally dispose accumulators occupying a relatively large area in the AI accelerator 300. Accordingly, it may be possible to realize compact AI accelerators.

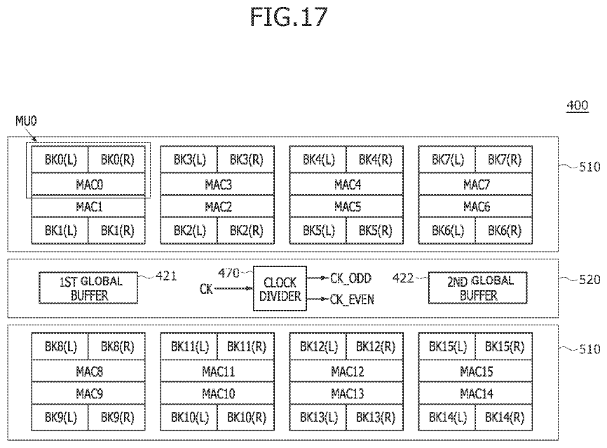

FIG. 17 is a block diagram illustrating an AI accelerator 400 according to yet another embodiment of the present disclosure. Referring to FIG. 17, the AI accelerator 400 may include a memory/arithmetic region 510 and a peripheral region 520. The memory/arithmetic region 510 may include a plurality of memory banks BKs and a plurality of MAC operators MACs. The peripheral region 520 may include a first global buffer 421, a second global buffer 422, and a clock divider 470. Although not shown in FIG. 17, a data I/O circuit may be disposed in the peripheral region 520, and the data I/O circuit disposed in the peripheral region 520 may include left data I/O terminals and right data I/O terminals, like the data I/O circuit 160 described with reference to FIG. 1. In the present embodiment, it may be assumed that the plurality of memory banks BKs include first to sixteenth memory banks BK0˜BK15. In addition, it may be assumed that the plurality of MAC operators MACs include first to sixteenth MAC operators MAC0˜MAC15.

Each of the first to sixteenth memory banks BK0˜BK15 may be divided into a left memory bank disposed in a left region and a right memory bank disposed in a right region. Accordingly, the first to sixteenth memory banks BK0˜BK15 may include first to sixteenth left memory banks BK0(L)˜BK15(L) and first to sixteenth right memory banks BK0(R)˜BK15(R). For example, the first memory bank BK0 may include the first left memory bank BK0(L) disposed in the left region and the first right memory bank BK0(R) disposed in the right region, and the second memory bank BK1 may include the second left memory bank BK1(L) disposed in the left region and the second right memory bank BK1(R) disposed in the right region. Similarly, the sixteenth memory bank BK15 may include the sixteenth left memory bank BK15(L) disposed in the left region and the sixteenth right memory bank BK15(R) disposed in the right region. In the present embodiment, the first to sixteenth left memory banks BK0(L)˜BK15(L) may be disposed to be adjacent to the first to sixteenth right memory banks BK0(R)˜BK15(R), respectively. For example, the first left memory bank BK0(L) and the first right memory bank BK0(R) may be disposed to be adjacent to each other and to share a row decoder with each other. The second left memory bank BK1(L) and the second right memory bank BK1(R) may also be disposed to be adjacent to each other. In the same way, the sixteenth left memory bank BK15(L) and the sixteenth right memory bank BK15(R) may also be disposed to be adjacent to each other.

The first to sixteenth MAC operators MAC0˜MAC15 may be disposed to be allocated to the first to sixteenth memory banks BK0˜BK15, respectively. For example, the first MAC operator MAC0 may be allocated to both of the first left memory bank BK0(L) and the first right memory bank BK0(R). In addition, the second MAC operator MAC1 may be allocated to both of the second left memory bank BK1(L) and the second right memory bank BK1(R). Similarly, the sixteenth MAC operator MAC15 may be allocated to both of the sixteenth left memory bank BK15(L) and the sixteenth right memory bank BK15(R). Each of the first to sixteenth MAC operators MAC0˜MAC15 and one of the first to sixteenth memory banks may constitute one MAC unit MU. For example, as illustrated in FIG. 17, the first left memory bank BK0(L), the first right memory bank BK0(R), and the first MAC operator MAC0 may constitute a first MAC unit MU0. Although not indicated in FIG. 17, each of second to sixteenth MAC units may also be configured in the same way as described above. A MAC operator included in a certain MAC unit may receive left weight data from a left memory bank included in the certain MAC unit and may receive right weight data from a right memory bank included in the certain MAC unit. Thus, the first MAC operator MAC0 may receive left weight data from the first left memory bank BK0(L) and may receive right weight data from the first right memory bank BK0(R).

The first global buffer 421 may transmit left vector data to each of the first to sixteenth MAC operators MAC0˜MAC15. The second global buffer 422 may transmit right vector data to each of the first to sixteenth MAC operators MAC0˜MAC15. The clock divider 470 may divide a clock signal CK, which is inputted to the AI accelerator 400, to generate and output an odd clock signal CK_ODD and an even clock signal CK_EVEN. The odd clock signal CK_ODD may be transmitted to a left accumulator in each of the first to sixteenth MAC operators MAC0˜MAC15. The even clock signal CK_ODD may be transmitted to a right accumulator in each of the first to sixteenth MAC operators MAC0˜MAC15. The first global buffer 421, the second global buffer 422, and the clock divider 470 may have substantially the same configurations as the first global buffer 121, the second global buffer 122, and the clock divider 170 of the AI accelerator 100 described with reference to FIG. 1, respectively.

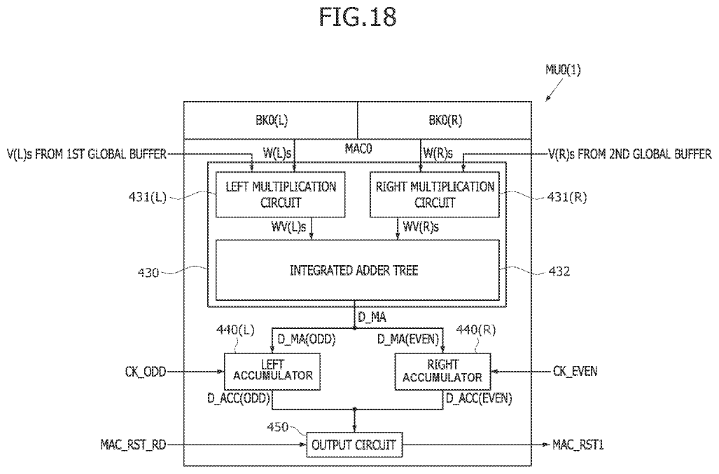

FIG. 18 is a block diagram illustrating a first MAC unit MU0(1) corresponding to an example of the first MAC unit MU0 included in the AI accelerator 400 of FIG. 17. The following descriptions for the first MAC unit MU0(1) may be equally applied to each of the remaining MAC units. Referring to FIG. 18, the first MAC unit MU0(1) may be comprised of the first left memory bank BK0(L), the first right memory bank BK0(R), and the first MAC operator MAC0, as described with reference to FIG. 17. The first left memory bank BK0(L) and the first right memory bank BK0(R) may have substantially the same configurations as the left memory bank 110(L) and the right memory bank 110(R) included in the AI accelerator 100 described with reference to FIG. 1, respectively. The first MAC operator MAC0 may include a multiplication circuit/adder tree 430, a left accumulator 440(L), a right accumulator 440(R), and an output circuit 450. The multiplication circuit/adder tree 430 may include a left multiplication circuit 431(L), a right multiplication circuit 431(R), and an integrated adder tree 432. The left multiplication circuit 431(L), the right multiplication circuit 431(R), the integrated adder tree 432, the left accumulator 440(L), the right accumulator 440(R), and the output circuit 450 constituting the first MAC operator MAC0 may have substantially the same configurations as the left multiplication circuit 131(L), the right multiplication circuit 131(R), the integrated adder tree 132, the left accumulator 140(L), the right accumulator 140(R), and the output circuit 150 constituting the AI accelerator 100 illustrated in FIG. 1, respectively. Accordingly, the left multiplication circuit 431(L), the right multiplication circuit 431(R), the integrated adder tree 432, the left accumulator 440(L), the right accumulator 440(R), and the output circuit 450 constituting the first MAC operator MAC0 may perform substantially the same operations as the left multiplication circuit 131(L), the right multiplication circuit 131(R), the integrated adder tree 132, the left accumulator 140(L), the right accumulator 140(R), and the output circuit 150 constituting the AI accelerator 100 illustrated in FIG. 1, respectively.

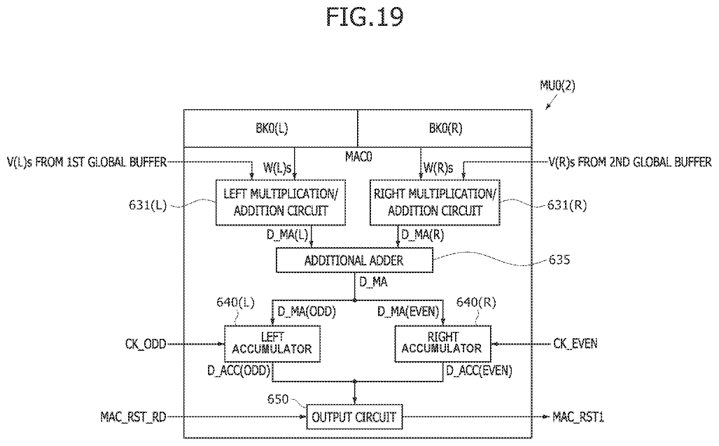

FIG. 19 is a block diagram illustrating a first MAC unit MU0(2) corresponding to another example of the first MAC unit MU0 included in the AI accelerator 400 of FIG. 17. The following descriptions for the first MAC unit MU0(2) may be equally applied to each of the remaining MAC units. Referring to FIG. 19, the first MAC unit MU0(2) may be comprised of the first left memory bank BK0(L), the first right memory bank BK0(R), and the first MAC operator MAC0, as described with reference to FIG. 17. The first left memory bank BK0(L) and the first right memory bank BK0(R) may have substantially the same configurations as the left memory bank 110(L) and the right memory bank 110(R) included in the AI accelerator 100 described with reference to FIG. 1, respectively. The first MAC operator MAC0 may include a left multiplication/addition circuit 631(L), a right multiplication/addition circuit 631(R), an additional adder 635, a left accumulator 640(L), a right accumulator 640(R), and an output circuit 650. The left multiplication/addition circuit 631(L), the right multiplication/addition circuit 631(R), the additional adder 635, the left accumulator 640(L), the right accumulator 640(R), and the output circuit 650 constituting the first MAC operator MAC0 may have substantially the same configurations as the left multiplication/addition circuit 331(L), the right multiplication/addition circuit 331(R), the additional adder 335, the left accumulator 140(L), the right accumulator 140(R), and the output circuit 150 constituting the AI accelerator 300 illustrated in FIG. 14, respectively. Accordingly, the left multiplication/addition circuit 631(L), the right multiplication/addition circuit 631(R), the additional adder 635, the left accumulator 640(L), the right accumulator 640(R), and the output circuit 650 constituting the first MAC operator MAC0 may perform substantially the same operations as the left multiplication/addition circuit 331(L), the right multiplication/addition circuit 331(R), the additional adder 335, the left accumulator 140(L), the right accumulator 140(R), and the output circuit 150 constituting the AI accelerator 300 illustrated in FIG. 14, respectively.

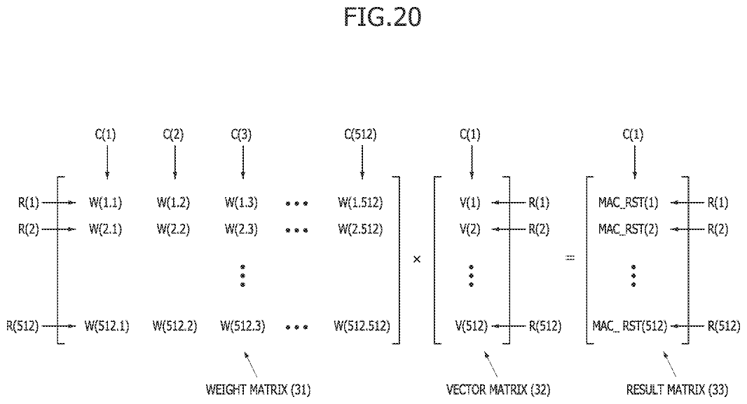

FIG. 20 illustrates a matrix multiplying calculation executed by a MAC operation of the AI accelerator 400 of FIG. 17. Referring to FIG. 20, the AI accelerator 400 may perform a MAC operation which is executed by a matrix multiplying calculation for multiplying a ‘M×N’ weight matrix 31 by a ‘N×1’ vector matrix 32 (where, “M” and “N” are natural numbers which are equal to or greater than two). The term “matrix multiplying calculation” may be construed as having the same meaning as the term “MAC operation”. The AI accelerator 400 may generate and output a ‘M×1’ result matrix 33 as a result of the MAC operation on the ‘M×N’ weight matrix 31 and the ‘N×1’ vector matrix 32. Hereinafter, it may be assumed that the weight matrix 31 has 512 rows (i.e., first to 512^{th} rows R(1)˜R(512)) and 512 columns (i.e., first to 512^{th} columns C(1)˜C(512)) and the vector matrix 32 has 512 rows (i.e., first to 512^{th} rows R(1)˜R(512)) and one column (i.e., a first column C(1)). Accordingly, the result matrix 33 generated by the matrix multiplying calculation on the weight matrix 31 and the vector matrix 32 may have 512 rows (i.e., first to 512^{th} rows R(1)˜R(512)) and one column (i.e., a first column C(1)). The weight matrix 31 may have 262,144 sets of weight data W(1.1)˜W(1.512), . . . , and W(512.1)˜W(512.512) as elements. The vector matrix 32 may have 512 sets of vector data V(1)˜V(512) as elements. The result matrix 33 generated by the MAC operation may have 512 sets of MAC result data MAC_RST(1)˜MAC_RST(512) as elements.

The AI accelerator 400 according to the present embodiment may have a plurality of memory banks BKs and a plurality of MAC operators MACs. Thus, a plurality of MAC operations may be simultaneously performed by the plurality of MAC operators MACs. Specifically, the first to sixteenth MAC operators MAC0˜MAC15 of the AI accelerator 400 may perform a first MAC operation on the weight data W(1.1)˜W(1.512), . . . , and W(16.1)˜W(16.512) arrayed in the first to sixteenth rows R(1)˜R(16) of the weight matrix 31 and the vector data V(1)˜V(512) arrayed in the first to sixteenth rows R(1)˜R(512) of the vector matrix 32, thereby generating and output sixteen sets of MAC result data (i.e., first to sixteenth MAC result data MAC_RST(1)˜MAC_RST(16)), respectively. Subsequently, the first to sixteenth MAC operators MAC0˜MAC15 of the AI accelerator 400 may perform a second MAC operation on the weight data W(17.1)˜W(17.512), . . . , and W(32.1)˜W(32.512) arrayed in the seventeenth to 32^{nd} rows R(17)˜R(32) of the weight matrix 31 and the vector data V(1)˜V(512) arrayed in the first to sixteenth rows R(1)˜R(512) of the vector matrix 32, thereby generating sixteen sets of MAC result data (i.e., seventeenth to 32^{nd} MAC result data MAC_RST(17)˜MAC_RST(32)), respectively. In the same way, the first to sixteenth MAC operators MAC0˜MAC15 of the AI accelerator 400 may perform third to 32^{nd} MAC operations to generate 33 rd to 512^{th} MAC result data MAC_RST(33)˜MAC_RST(512).

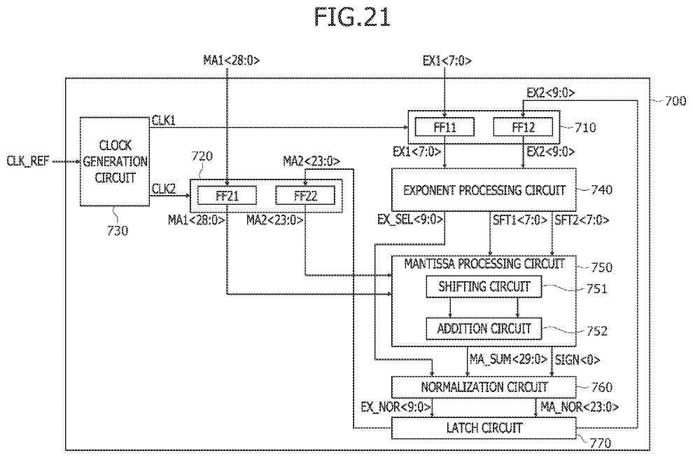

FIG. 21 is a block diagram illustrating an accumulator 700 according to an embodiment of the present disclosure. The accumulator 700 may be applied to the accumulator used in various examples of the artificial intelligence accelerator described with reference to FIG. 1 to FIG. 20.

Referring to FIG. 21, the accumulator 700 accumulates input data to latch data. In this example, the input data includes 8-bit first exponent data EX1<7:0> and 29-bit first mantissa data MA1<28:0>. The latch data includes 10-bit second exponent data EX2<9:0> and 24-bit second mantissa data MA2<23:0>. The accumulator 700 includes an exponent data latch circuit 710, a mantissa data latch circuit 720, a clock generation circuit 730, an exponent processing circuit 740, a mantissa processing circuit 750, a normalization circuit 760, and a latch circuit 770.

The exponent data latch circuit 710 receives the first exponent data EX1<7:0> of the input data and the second exponent data EX2<9:0> of the latch data. The exponent data latch circuit 710 receives the first exponent data EX1<7:0> from an external circuit that is disposed outside the accumulator 700. The exponent data latch circuit 710 receives the second exponent data EX2<9:0> from the latch circuit 770 in the accumulator 700. The exponent data latch circuit 710 latches the first exponent data EX1<7:0> and the second exponent data EX2<9:0> and outputs the first exponent data EX1<7:0> and the second exponent data EX2<9:0> in synchronization with a first clock signal CLK1. The exponent data latch circuit 710 may include a first flip-flop FF11 and a second flip-flop FF12. The first flip-flop FF11 receives the first exponent data EX1<7:0> and outputs the first exponent data EX1<7:0> in synchronization with the raising edge (or falling edge) of the first clock signal CLK1. The second flip-flop FF12 receives the second exponent data EX2<9:0> and outputs the second exponent data EX2<9:0> in synchronization with the raising edge (or falling edge) of the first clock signal CLK1. When the first exponent data EX1<7:0> is output in synchronization with the raising edge of the first clock signal CLK1, the second exponent data EX2<9:0> is also output in synchronization with the raising edge of the first clock signal CLK1. Similarly, when the first exponent data EX1<7:0> is output in synchronization with the falling edge of the first clock signal CLK1, the second exponent data EX2<9:0> is also output in synchronization with the falling edge of the first clock signal CLK1.

The mantissa data latch circuit 720 receives the first mantissa data MA1<28:0> of the input data and the second mantissa data MA2<23:0> of the latch data. The mantissa data latch circuit 720 receives the first mantissa data MA1<28:0> from the external circuit. The mantissa data latch circuit 720 receives the second mantissa data MA2<23:0> from the latch circuit 770 in the accumulator 700. After latching the first mantissa data MA1<28:0> and the second mantissa data MA2<23:0>, the mantissa data latch circuit 720 outputs the first mantissa data MA1<28:0> and the second mantissa data MA2<23:0> in synchronization with a second clock signal CLK2. The mantissa data latch circuit 720 may include a third flip-flop FF21 and a fourth flip-flop FF22. The third flip-flop FF21 receives the first mantissa data MA1<28:0> and outputs the first mantissa data MA1<28:0> in synchronization with the raising edge (or falling edge) of the second clock signal CLK2. The fourth flip-flop FF22 receives the second mantissa data MA2<23:0> and outputs the second mantissa data MA2<23:0> in synchronization with the raising edge (or falling edge) of the second clock signal CLK2. When the first mantissa data MA1<28:0> is output in synchronization with the raising edge of the second clock signal CLK2, the second mantissa data MA2<23:0> is also output in synchronization with the raising edge of the second clock signal CLK2. Similarly, when the first mantissa data MA1<28:0> is output in synchronization with the falling edge of the second clock signal CLK2, the second mantissa data MA2<23:0> is also output in synchronization with the falling edge of the first clock signal CLK2.

The clock generation circuit 730 generates and outputs the first clock signal CLK1 and the second clock signal CLK2 based on a reference clock signal CLK_REF that is transmitted from the outside of the accumulator 700. The clock generation circuit 730 outputs the second clock signal CLK2 when a delay time elapses after outputting the first clock signal CLK1. That is, there is a time interval equal to the delay time between the edge occurrence time of the first clock signal CLK1 and the edge occurrence time of the second clock signal CLK2. The clock generation circuit 730 transmits the first clock signal CLK1 and the second clock signal CLK2 to the exponent data latch circuit 710 and the mantissa data latch circuit 720, respectively.

The exponent processing circuit 740 receives the first exponent data EX1<7:0> and the second exponent data EX2<9:0> from the first flip-flop FF11 and the second flip-flop FF12 of the exponent data latch circuit 710, respectively. The exponent processing circuit 740 performs an exponent process on the first exponent data EX1<7:0> and the second exponent data EX2<9:0> to generate and output first shift data SFT1<7:0>, second shift data SFT2<7:0>, and exponent selection data EX_SEL<9:0>. In one example, the first shift data SFT1<7:0> and the second shift data SFT2<7:0> may have the same number of bits (i.e., 8 bits) as the first exponent data EX1<7:0>. And the exponent selection data EX_SEL<9:0> may have the same number of bits (i.e., 10 bits) as the second exponent data EX2<9:0>.

More specifically, the exponent processing circuit 740 generates exponent subtraction data by performing an exponent subtraction operation that subtracts the second exponent data EX2<9:0> from the first exponent data EX1<7:0>. The exponent processing circuit 740 outputs exponent subtraction data as the second shift data SFT2<7:0> or outputs the 2's complement of the exponent subtraction data as the first shift data SFT1<7:0> based on the sign of the exponent subtraction data. In one example, when the most significant bit (MSB) of the exponent subtraction data is a binary value of “1” (namely, the exponent subtraction data is negative number), the second exponent data EX2<9:0> is greater than the first exponent data EX1<7:0>. In this case, the exponent processing circuit 740 outputs the 2's complement of the exponent subtraction data as the first shift data SFT1<7:0> and outputs “0000 0000” as the second shift data SFT2<7:0>. Also, the exponent processing circuit 740 outputs the second exponent data EX2<9:0> having a relatively large value as the exponent selection data EX_SEL<9:0>. When the most significant bit (MSB) of the exponent subtraction data is a binary value of “0” (namely, the exponent subtraction data is positive number), the first exponent data EX1<7:0> is greater than the second exponent data EX2<9:0>. In this case, the exponent processing circuit 740 outputs “0000 0000” as the first shift data SFT1<7:0> and outputs the exponent subtraction data as the second shift data SFT2<7:0>. Also, the exponent processing circuit 740 outputs the first exponent data EX1<7:0> having a relatively large value as the exponent selection data EX_SEL<9:0>.

The mantissa processing circuit 750 receives the first mantissa data MA1<28:0> from the third flip-flop FF21 of the mantissa data latch circuit 720. The mantissa processing circuit 750 receives the second mantissa data MA2<23:0> from the fourth flip-flop FF22 of the mantissa data latch circuit 720. The mantissa processing circuit 750 receives first shift data SFT1<7:0> and second shift data SFT2<7:0> from the exponent processing circuit 740. The mantissa processing circuit 750 performs a mantissa processing process on the first mantissa data MA1<28:0> and the second mantissa data MA2<23:0> using the first shift data SFT1<7:0> and the second shift data SFT2<7:0>. The mantissa processing circuit 750 generates and outputs the mantissa addition data MA_SUM<29:0> by the mantissa processing process. The mantissa-processing circuit 750 includes a shifting circuit 751 and an addition circuit 752.

The shifting circuit 751 of the mantissa processing circuit 750 may include a first mantissa shifter performing a first shift operation on the first mantissa data MA1<28:0> and a second mantissa shifter performing a second shift operation on the second mantissa data MA2<23:0>. The first mantissa shifter receives first mantissa data MA1<28:0> that is output from the third flip-flop FF21 of the mantissa data latch circuit 720 and first shift data SFT1<7:0> that is output from the exponent processing circuit 740. The second mantissa shifter receives second mantissa data MA2<23:0> that is output from the third flip-flop FF21 of the mantissa data latch circuit 720 and second shift data SFT2<7:0> that is output from the exponent processing circuit 740. The first mantissa shifter shifts the first mantissa data MA1<28:0> based on the first shift data SFT1<7:0> and outputs the first shifted mantissa data. The second mantissa shifter shifts the second mantissa data MA2<23:0> based on the second shift data SFT2<7:0> and outputs the second shifted mantissa data.

The addition circuit 752 of the mantissa processing circuit 750 receives the first shifted mantissa data and the second shifted mantissa data that is output from the shifting circuit 751. The addition circuit 752 generates and outputs mantissa addition data MA_SUM<29:0> by performing an addition operation on the first shifted mantissa data and the second shifted mantissa dat. In addition, the addition circuit 752 outputs 1-bit sign data (SIGN<0>) indicating the sign of the mantissa addition data MA_SUM<29:0>. In one example, the mantissa addition data MA_SUM<29:0> includes 1-bit carry data that is added by the addition operation. In one example, the sign data SIGN<0> may be added as the most significant bit (MSB) of the mantissa addition data MA_SUM. In this case, the mantissa processing circuit 750 may output 31 bits of the mantissa addition data MA_SUM<30:0> without outputting the sign data SIGN<0>. The addition circuit 752 transmits the mantissa addition data MA_SUM<29:0> and the sign data SIGN<0> to the normalization circuit 760.

The normalization circuit 760 receives the exponent selection data EX_SEL<9:0> that is output from the exponent processing circuit 740, the mantissa addition data MA_SUM<29:0> and the sign data SIGN<0> that are output from the mantissa processing circuit 750. The normalization circuit 760 performs a mantissa normalization process and an exponent normalization process based on the exponent selection data EX_SEL<9:0>, the mantissa addition data MA_SUM<29:0>, and the sign data SIGN<0>. The mantissa normalization process may be performed by searching for “leading 1” to determine the number of mantissa shift bits and by shifting the mantissa addition data MA_SUM<29:0> or 2's complement of the mantissa addition data MA_SUM<29:0> based on the number of the mantissa shift bits. The exponent normalization process may be performed by an addition operation on the exponent selection data EX_SEL<9:0> based on the number of the mantissa shift bits.

More specifically, the normalization circuit 760 searches for the position of “leading 1” in the mantissa addition data MA_SUM<29:0> or the 2's complement of the mantissa addition data MA_SUM<29:0>. When the sign data SIGN<0> has a binary value of “0”, the normalization circuit 760 searches for the position of “leading 1” in the mantissa addition data MA_SUM<29:0>. On the other hand, when the sign data SIGN<0> has a binary value of “1”, the normalization circuit 760 searches the position of “leading 1” in the 2's complement of the mantissa addition data MA_SUM<29:0>.

Once the position of “leading 1” is retrieved, the normalization circuit 760 determines the number of mantissa shifts to ensure that the binary point is located to the right of “leading 1” so that the mantissa addition data MA_SUM<29:0> or the 2's complement of the mantissa addition data MA_SUM<29:0> has a normalized mantissa format. When the sign data SIGN<0> has a binary value of “0”, the normalization circuit 760 makes the mantissa addition data MA_SUM<29:0> have the normalized mantissa format. On the other hand, when the sign data SIGN<0> has a binary value of “1”, the normalization circuit 760 makes the 2's complement of the mantissa addition data MA_SUM<29:0> have the normalized mantissa format.

Once the number of the mantissa shift bits is determined, the normalization circuit 760 performs a shift operation on the mantissa addition data MA_SUM<29:0> (when the sign data (SIGN<0>) is “0”) or the 2's complement of the mantissa addition data MA_SUM<29:0> (when the sign data MA_SUM<29:0> is “1”) based on the number of the mantissa shift bits. That is, when the sign data SIGN<0> is a binary value of “0”, the normalization circuit 760 shifts the mantissa addition data MA_SUM<29:0> by the number of the mantissa shift bits to generate and output normalized mantissa data MA_NOR<23:0>. When the sign data SIGN<0> is a binary value of “1”, the normalization circuit 760 shifts the 2's complement of the mantissa addition data MA_SUM<29:0> by the number of the mantissa shift bits to generate and output the normalized mantissa data MA_NOR<23:0>.

Once the number of the mantissa shift bits is determined, the normalization circuit 760 performs an addition operation on the exponent selection data EX_SEL<9:0> based on the number of the mantissa shift bits. That is, the normalization circuit 760 adds a binary value corresponding to the number of the mantissa shift bits to the exponent selection data EX_SEL<9:0> to generate and output normalized exponent data EX_NOR<9:0>. The normalization circuit 760 transmits the normalized exponent data EX_NOR<9:0> and the normalized mantissa data MA_NOR<23:0> to the latch circuit 770.

The latch circuit 770 latches the normalized exponent data EX_NOR<9:0> and the normalized mantissa data MA_NOR<23:0> that is output from the normalization circuit 760. Although omitted in the drawing, the latch circuit 770 may include a first latch circuit that latches the normalized exponent data EX_NOR<9:0> and a second latch circuit that latches the normalized mantissa data MA_NOR<23:0>. The latch circuit 770 transmits the normalized exponent data EX_NOR<9:0> to the second flip-flop FF12 of the exponent data latch circuit 710 as the second exponent data EX2<9:0>. Also, the latch circuit 770 transmits the normalized mantissa data MA_NOR<23:0> to the fourth flip-flop FF22 of the mantissa data latch circuit 720 as the second mantissa data MA2<23:0>. Although omitted in the drawings, latch circuit 770 is coupled to an output line of accumulator 700.

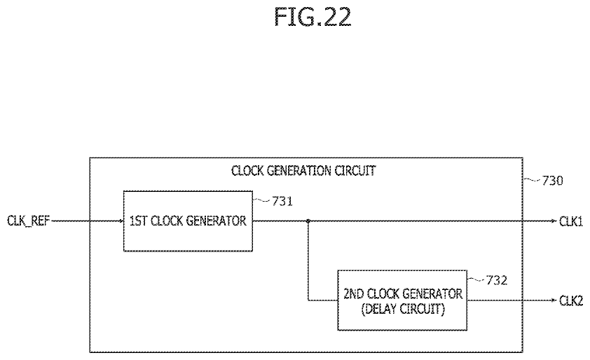

FIG. 22 is a block diagram illustrating an embodiment of the clock generation circuit 730 included in the accumulator 700 of FIG. 21.

Referring to FIG. 22, the clock generation circuit 730 receives the reference clock signal CLK_REF. The clock generation circuit 730 generates and outputs the first clock signal CLK1 and the second clock signal CLK2. The clock generation circuit 730 includes the first clock generator 731 and the second clock generator 732. The first clock generator 731 generates and outputs the first clock signal CLK1 based on the reference clock signal CLK_REF. The first clock signal CLK1 is transmitted to the exponent data latch circuit 710 and the second clock generator 732. In one example, the first clock generator 731 may output the reference clock signal CLK_REF as the first clock signal CLK1. In another example, the first clock generator 731 may generate and output the first clock signal CLK1 by changing the period of the reference clock signal CLK_REF. The second clock generator 732 generates and outputs the second clock signal CLK2 based on the first clock signal CLK1 that is output from the first clock generator 731. The second clock generator 732 may be configured as a delay circuit. Accordingly, the second clock signal CLK2 may have a waveform in which the first clock signal CLK1 is delayed for a predetermined time. The second clock signal CLK2 is transmitted to the mantissa data latch circuit 720.

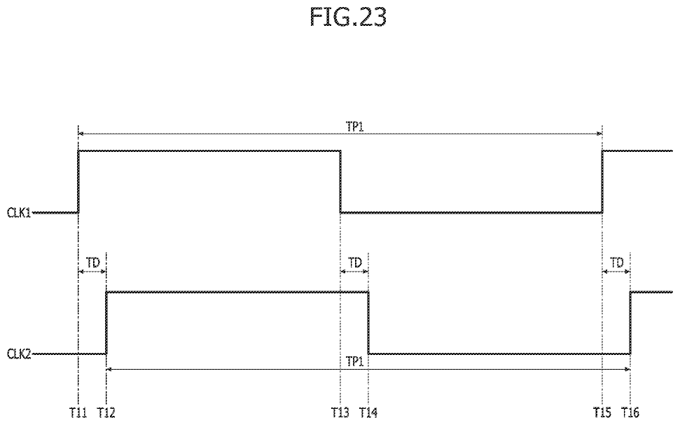

FIG. 23 is a timing diagram illustrating an embodiment of waveforms of the first clock signal and the second clock signal output from the clock generation circuit 730 of FIG. 22.

Referring to FIG. 23, at a first time point T11, a first raising edge of the first clock signal CLK1 is occurred. At a second time point T12 when the delay time period TD has elapsed from the first time point T11, a first raising edge of the second clock signal CLK2 is occurred. As described with reference to FIG. 22, because the second clock signal CLK2 is a signal in which the first clock signal CLK1 is delayed by the delay time period TD, the first clock signal CLK1 and the second clock signal CLK2 have the same period TP1. Accordingly, at the fourth time point T14 when the delay time period TD elapses from the third time point T13 when a first falling edge of the first clock signal CLK1 is occurred, a first falling edge of the second clock signal CLK2 is occurred. At a fifth time point T15 when the period TP1 has elapsed from the first time point T11 when the first raising edge of the first clock signal CLK1 is occurred, a second raising edge of the first clock signal CLK1 is occurred. Similarly, at a sixth time point T16 when the period TP1 has elapsed from the second time point T12 when the first raising edge of the second clock signal CLK2 is occurred, a second raising edge of the second clock signal CLK2 is occurred. The time interval between the fifth time point T15 at which the second raising edge of the first clock signal CLK1 occurs and the sixth time point T16 at which the second raising edge of the second clock signal CLK2 occurs corresponds to the delay time period TD.

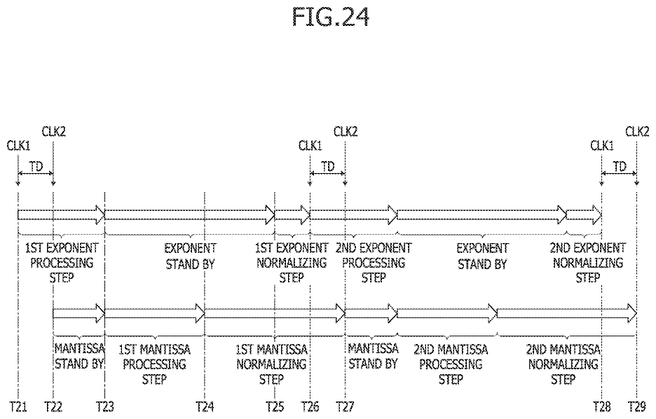

FIG. 24 is a timing diagram illustrating an example of a time required for an accumulating operation in the accumulator 700 of FIG. 21.

Referring to FIG. 24 together with FIG. 21, at the first time point T21, when the first raising edge of the first clock signal CLK1 that is transmitted to the exponent data latch circuit 710 is occurred, the first exponent data EX1<7:0> and the second exponent data EX2<9:0> are transmitted from the exponent data latch circuit 710 to the exponent processing circuit 740. The exponent processing circuit 740 performs a first exponent processing step using the first exponent data EX1<7:0> and the second exponent data EX2<9:0>. At a second time point T22 when the delay time period TD elapses from the first time point T21 when the first raising edge of the first clock signal CLK1 is occurred, the first mantissa data MA1<28:0> and the second mantissa data MA2<23:0> are transmitted from the mantissa data latch circuit 720 to the mantissa processing circuit 750. As described with reference to FIG. 21, the first mantissa processing step in the mantissa processing circuit 750 may be started after the first exponent processing step in the exponent processing circuit 740 is completed. Accordingly, the delay time period TD is set to a time shorter than the time when the first exponent processing step is performed in the exponent processing circuit 740.

At the second time point T22, the mantissa processing circuit 740 that receives the first mantissa data MA1<28:0> and the second mantissa data MA2<23:0> from the mantissa data latch circuit 720 stands by until the third time point T23 when the first exponent processing step in the exponent processing circuit 740 is completed. When the first exponent processing step in the exponent processing circuit 740 is completed at the third time point T23, the first shift data SFT1<7:0> and the second shift data SFT2<7:0> are transmitted from the exponent processing circuit 740 to the mantissa processing circuit 750. In addition, the exponent selection data EX_SEL<9:0> is transmitted from the exponent processing circuit 740 to the normalization circuit 760. At the third time point T23 when the first shift data SFT1<7:0> and the second shift data SFT2<7:0> are transmitted, the mantissa processing circuit 750 performs the first mantissa processing process. At the fourth time point T24 when the first mantissa-processing process in the mantissa-processing circuit 750 is completed, the mantissa-addition data MA_SUM<30:0> and the sign data SIGN<0> are transmitted from the mantissa-processing circuit 750 to the normalization circuit 760.

At the fourth time point T24, the normalization circuit 760 performs a first mantissa normalizing step. As described with reference to FIG. 21, the first exponent normalizing step in the normalization circuit 760 may be performed after the number of the mantissa shift bits is determined by the mantissa normalizing process. Accordingly, the first exponent normalization process is suspended until the number of the mantissa shift bits is determined. At the fifth time point T25 at which the number of the mantissa shift bits is determined, the normalization circuit 760 performs both a mantissa shift operation and an exponent addition operation. At the fifth time point T25 when the number of the mantissa shift bits is determined, the normalization circuit 760 starts to perform the mantissa shift operation and the exponent addition operation at substantially the same time point. Because the time required for the exponent addition operation is shorter than the time required for the mantissa shift operation, the first exponent normalization process is completed at the sixth time point T26, and the first mantissa normalization process is completed at the seventh time point T27, which is later than the sixth time T26. Accordingly, at the sixth time point T26, the normalized exponent data EX_NOR<9:0> is output from the normalization circuit 760. And at the seventh time point T27, the normalized mantissa data MA_NOR<23:0> is output from the normalization circuit 760.

At the sixth time point T26 when the normalized exponent data EX_NOR<9:0> is output from the normalization circuit 760A, the second raising edge of the first clock signal CLK1 is occurred. And at the seventh time point T27 when the normalized mantissa data MA_NOR<23:0> is output from the normalization circuit 760, the second raising edge of the second clock signal CLK2 occurs. During the time period from the sixth time point T26 to the eighth time point T28 when one period TP1 of the first clock signal CLK1 has elapsed from the sixth time point T26, a second exponent processing step and the second exponent normalization process are performed in the same manner as the first exponent processing step and the second exponent normalization process that is performed during the time period form the first time point T21 to the sixth time point T26, respectively. Similarly, during the time period from the seventh time point T27 to the ninth time point T29 when one period TP1 of the second clock signal CLK2 has elapsed from the seventh time point T27, a second mantissa processing process and a second mantissa normalization process are performed in the same manner as the first mantissa processing process and the second mantissa normalization process that is performed during the time period form the second time point T22 to the seventh time point T27, respectively.

As described above, the first exponent normalization process may be performed after the number of the mantissa shift bits is determined by the first mantissa normalization process. In addition, the mantissa shift operation of the first mantissa normalization process may also be performed after the mantissa shift bit number is determined. The first exponent normalization process is performed at the fifth time point T25 when the number of the mantissa shift bits is determined, and the first exponent normalization process is completed at the sixth time point T26. On the other hand, the mantissa shift operation of the first mantissa normalization process is performed at the fifth time point T25, and the first mantissa normalization process is completed at the seventh time point T27. Because the normalized exponent data EX_NOR<9:0> is output from the normalization circuit 760 at the sixth time point T26 when the normalized exponent data EX_NOR<9:0> is generated by the first exponent normalization process, and the second exponent processing step is performed at the sixth time point T26, the time required for the second exponent processing step is reduced by the time interval between the completion of the first exponent normalization process at the time point T26 and the completion of the first mantissa normalization process at the seventh time point T27. That is, when the delay time period TD between the first clock signal CLK1 and the second clock signal CLK2 is set to the time interval between the sixth time point T26 when the first exponent normalization process is completed and the seventh time point T27 when the first exponent normalization process is completed, the exponent process may be shortened by the delay time period TD. Accordingly, the delay time corresponding to the phase difference between the first clock signal CLK1 and the second clock signal CLK2 may be set to a time corresponding to the time difference between the time required for the mantissa shifting operation and the time required the exponent addition operation in the normalization circuit 760. As the exponent process is reduced by delay time period (TD), from the second exponent processing step, the time point when the first shift data SFT1<7:0> and the second shift data SFT2<7:0> are transmitted to the mantissa processing circuit 750 by the exponent processing step is also shortened by delay time period TD, and consequently, the time required from the second mantissa processing step is shortened by the delay time period TD.

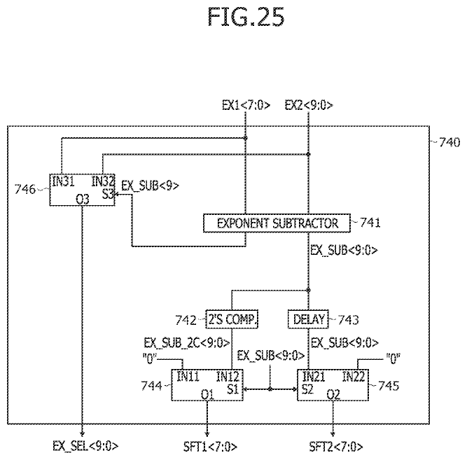

FIG. 25 is a block diagram illustrating an embodiment of the exponent processing circuit 740 included in the accumulator 700 of FIG. 21.

Referring to FIG. 25, the exponent processing circuit 740 includes an exponent subtractor 741, a 2's complement circuit 742, a delay circuit 743, a first multiplexer 744, a second multiplexer 745, and a third multiplexer 746.

The exponent subtractor 741 receives the first exponent data EX1<7:0> and the second exponent data EX2<9:0> from the exponent data latch circuit 710 in FIG. 21. The exponent subtractor 741 performs a subtraction operation of subtracting the second exponent data EX2<9:0> from the first exponent data EX1<7:0> and outputs the subtraction operation result as exponent subtraction data EX_SUB<9:0>. The exponent subtractor 741 transmits the exponent subtraction data EX_SUB<9:0> to the 2's complement circuit 742 and the delay circuit 743. The exponent subtractor 741 transmits the most significant bit (MSB) EX_SUB<9> of the exponent subtraction data EX_SUB<9:0> to the selection terminals S1, S2, and S3 of the first multiplexer 744, the second multiplexer 745, and the third multiplexer 746. When the first exponent data EX1<7:0> has a value greater than the second exponent data EX2<9:0>, the most significant bit (MSB) EX_SUB<9:0> of the exponent subtraction data EX_SUB<9:0> has a binary value of “0”. On the other hand, when the second exponent data EX2<9:0> has a value greater than the first exponent data EX1<7:0>, the most significant bit (MSB) EX_SUB<9:0> of the exponent subtraction data EX_SUB<9:0> has a binary value of “1”.

The 2's complement circuit 742 of 2 generates and outputs 2's complement EX_SUB_2C<9:0> of the exponent selection data EX_SEL<9:0> that is output from the exponent subtractor 741. The 2's complement circuit 742 transmits the 2's complement EX_SUB_2C<9:0> of the exponent subtraction data to the first multiplexer 744. The delay circuit 743 delays the exponent subtraction data EX_SUB<9:0> that is output from the exponent subtractor 741 for a predetermined time, and then outputs the exponent subtraction data EX_SUB<9:0> to the second multiplexer 745. The delay time in the delay circuit 743 may be set to the time required for generating the 2's complement EX_SUB_2C<9:0> of the exponent subtraction data in the 2's complement circuit 742.

The first multiplexer 744 receives “0” through the first input terminal IN11 and receives the 2's complement EX_SUB_2C<9:0> of the exponent subtraction data that is transmitted from the 2's complement circuit 742 through the second input terminal IN12. When the binary value of “0” as the most significant bit of the exponent subtraction data (MSB) EX_SUB<9> is transmitted to the selection terminal S1 of the first multiplexer 744, the first multiplexer 744 outputs “0” that is transmitted to the first input terminal IN11 as the first shift data SFT1<7:0> through an output terminal O1. On the other hand, when the binary value of “1” as the most significant bit of exponent subtraction data (MSB) EX_SUB<9> is transmitted to the selection terminal S1 of the first multiplexer 744, the first multiplexer 744 outputs the 2's complement EX_SUB_2C<9:0> of the exponent subtraction data that is transmitted to the second input terminal IN12 as the first shift data SFT1<7:0> through the output terminal O1.

The second multiplexer 745 receives exponent subtraction data EX_SUB<9:0> from the delay circuit 743 through the first input terminal IN21 and receives “0” through the second input terminal IN22. When the binary value of “0” as the most significant bit (MSB) EX_SUB<9> of exponent subtraction data is transmitted to the selection terminal S2 of the second multiplexer 745, the second multiplexer 745 outputs the exponent subtraction data EX_SUB<9:0> that is transmitted to the first input terminal IN21 as the second shift data SFT2<7:0> through an output terminal O2. On the other hand, when the binary value of “1” as the most significant bit (MSB) EX_SUB<9> of exponent subtraction data is transmitted to the selection terminal S2 of the second multiplexer 745, the second multiplexer 745 outputs “0” that is transmitted to the second input terminal IN22 as the second shift data SFT2<7:0> through the output terminal O2.

The third multiplexer 746 receives the first exponent data EX1<7:0> and second exponent data EX2<9:0> from the exponent data latch circuit 710 through the first input terminal IN31 and the second input terminal IN32, respectively. The third multiplexer 746 outputs exponent data having a large value among the first exponent data EX1<7:0> and the second exponent data EX2<9:0> as the exponent selection data EX_SEL<9:0>. Specifically, when the binary value of “0” as the most significant bit (MSB) EX_SUB<9> of the exponent subtraction data EX_SUB<9:0> is transmitted to the selection terminal S3 of the third multiplexer 746, the third multiplexer 746 selects the first exponent data EX1<7:0> and outputs the first exponent data EX1<7:0> as the exponent selection data EX_SEL<9:0> through an output terminal O3. On the other hand, when the binary value of “1” as the most significant bit (MSB) EX_SUB<9> of the exponent subtraction data EX_SUB<9:0> is transmitted to the selection terminal S3 of the third multiplexer 746, the third multiplexer 746 selects the second exponent data EX2<9:0> and output the second exponent data EX2<9:0> as the exponent selection data EX_SEL<9:0> through the output terminal O3.

As described above, when the first exponent data EX1<7:0> is greater than the second exponent data EX2<9:0>, the first exponent data EX1<7:0> is output as the exponent selection data EX_SEL<9:0> from the third multiplexer 746. And “0” is output as the first shift data SFT1<7:0> through the first multiplexer 744, and the exponent subtraction data EX_SUB<9:0> is output as the second shift data SFT2<7:0> from the second multiplexer 745. On the other hand, when the second exponent data EX2<9:0> is larger than the first exponent data EX1<7:0>, the second exponent data EX2<9:0> is output as exponent selection data EX_SEL<9:0> from the third multiplexer 746. And the 2's complement EX_SUB_2C<9:0> of exponent subtraction data is output as the first shift data SFT1<7:0> from the first multiplexer 744, and “0” is output as the second shift data SFT2<7:0> from the second multiplexer 745.

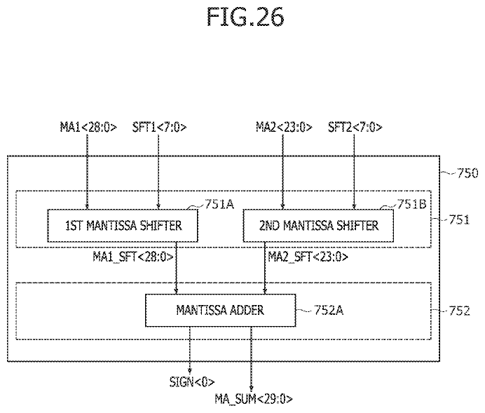

FIG. 26 is a block diagram illustrating an embodiment of the mantissa processing circuit 750 included in the accumulator 700 of FIG. 21.

Referring to FIG. 26, the mantissa processing circuit 750 includes the shifting circuit 751 and the addition circuit 752. The shifting circuit 751 includes a first mantissa shifter 751A and a second mantissa shifter 751B. The addition circuit 752 includes a mantissa adder 752A.

The first mantissa shifter 751A receives the first mantissa data MA1<28:0> from the mantissa data latch circuit 720 and the first shift data SFT1<7:0> from the first multiplexer 744 of the exponent processing circuit 740. The first mantissa shifter 751A generates and outputs the first shifted mantissa data MA1_SFT<28:0> by shifting the first mantissa data MA1<28:0> by the number of the first shift bits corresponding to the decimal value of the first shift data SFT1<7:0>. The shift in the first mantissa shifter 751A is performed in the right direction of a binary point.

The second mantissa shifter 751B receives the second mantissa data MA2<23:0> from the mantissa data latch circuit 720 and the second shift data SFT2<7:0> from the second multiplexer 745 of the exponent processing circuit 740. The second mantissa shifter 751B generates and outputs the second shifted mantissa data MA2_SFT<23:0> by shifting the second mantissa data MA2<23:0> by the number of second shift bits corresponding to the decimal value of the second shift data SFT2<7:0>. The shift in the second mantissa shifter 751B is also performed in the right direction of a binary point.

The mantissa adder 752A receives the first shifted mantissa data MA1_SFT<28:0> and the second shifted mantissa data MA2_SFT<23:0> from the first mantissa shifter 751A and the second mantissa shifter 752, respectively. The mantissa adder 752A generates and outputs mantissa addition data MA_SUM<30:0> by performing an addition operation on the first shifted mantissa data MA1_SFT<28:0> and the second shifted mantissa data MA2_SFT<23:0>. Although not shown in the drawings, the mantissa adder 752A may receive first sign data of the input data and second sign data of the latch data. The mantissa adder 752A outputs sign data SIGN<0> indicating the sign of the mantissa addition data MA_SUM<30:0>.

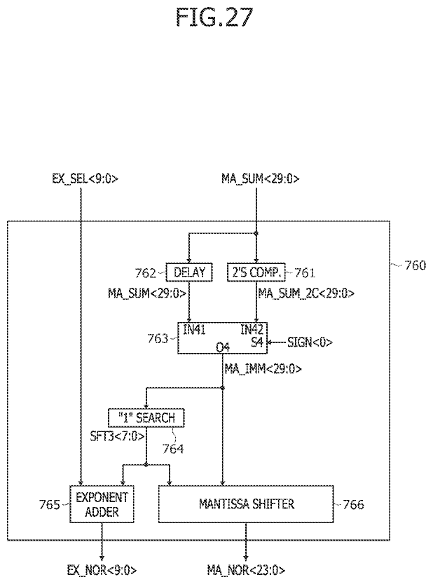

FIG. 27 is a block diagram illustrating an embodiment of the normalization circuit 760 included in the accumulator 700 of FIG. 21.

Referring to FIG. 27, the normalization circuit 760 includes a 2's complement circuit 761, a delay circuit 762, a multiplexer 763, a “1” search circuit 764, an exponent adder 765, and a mantissa shifter 766.

The 2's complement circuit 761 receives the mantissa addition data MA_SUM<29:0> from the mantissa adder 752A of the mantissa processing circuit 750. The 2's complement circuit 761 generates and outputs 2's complement MA_SUM_2C<29:0> of the mantissa addition data MA_SUM<29:0>. The 2's complement circuit 761 transmits the 2's complement MA_SUM_2C<29:0> of the mantissa addition data to the multiplexer 763. The delay circuit 762 receives the mantissa addition data MA_SUM<29:0> from the mantissa adder 752A of the mantissa processing circuit 750. The delay circuit 762 delays the mantissa addition data MA_SUM<29:0> for a predetermined time, and then transmits the mantissa addition data MA_SUM<29:0> to the multiplexer 763. The delay time in the delay circuit 762 may be set to the time required to generate the 2's complement MA_SUM_2C<29:0> of the mantissa addition data in the 2's complement circuit 761.

The multiplexer 763 receives the mantissa addition data MA_SUM<29:0> that is output from the delay circuit 762 through a first input terminal IN41. The multiplexer 763 receives the 2's complement MA_SUM_2C<29:0> of the mantissa addition data that is output from the 2's complement circuit 761 through a second input terminal IN42. In addition, the multiplexer 763 receives sign data SIGN<0> that is output from the mantissa adder 752A of the mantissa processing circuit 760 through a selection terminal S4. When “0” as the sign data SIGN<0> is transmitted to the selection terminal (i.e., the mantissa addition data MA_SUM<29:0> is positive number), the multiplexer 763 outputs the mantissa addition data MA_SUM<29:0> that is transmitted to the first input terminal IN41 through an output terminal O4. On the other hand, when “1” as the sign data SIGN<0> is transmitted to the selection terminal (S4), (i.e., when the mantissa addition data MA_SUM<29:0> is negative number), the multiplexer 763 outputs the 2's complement MA_SUM_2C<29:0> of the mantissa addition data that is transmitted to the first input terminal IN41 through the output terminal O4. Hereinafter, data output from the multiplexer 763 will be referred to as mantissa intermediate data MA_IMM<29:0>. When the sign data SIGN<0> is “0”, the mantissa intermediate data MA_IMM<29:0> is the mantissa addition data MA_SUM<29:0>. When the sign data SIGN<0> is “1”, the mantissa intermediate data MA_IMM<29:0> is the 2's complement MA_SUM_2C<29:0> of the mantissa addition data. The mantissa intermediate data MA_IMM<29:0> that is output from the multiplexer 763 is transmitted to the “1” search circuit 764 and the mantissa shifter 766.

The “1” search circuit 764 generates and outputs the third shift data SFT3<7:0> by searching the position of “leading 1” of the mantissa intermediate data MA_IMM<29:0> that is transmitted from the multiplexer 763. The process of searching “leading 1” may be performed by detecting the first location of a bit with a “1” in the rightward direction from the leftmost bit of the mantissa intermediate data MA_IMM<29:0>. The third shift data SFT3<7:0> defines the number of the mantissa shift bits. For example, if the mantissa intermediate data MA_IMM<29:0> is “1000 0000.0001 0100 1001 0111 0111 11,” the bit interval between “leading 1” and the binary point is 7 bits. In other words, by shifting the mantissa intermediate data MA_IMM<29:0>7 bits in the right direction of a binary point, the mantissa intermediate data MA_IMM<29:0> may be represented in the standard format of 1.x (where x is a binary number). In this case, the third shift data SFT3>7:0> is composed of a binary number corresponding to “7”, that is, “0000 0111,” and the number of the mantissa shift bits is defined as “7”, which is the decimal value of the third shift data SFT3>7:0>. The “1” search circuit 764 transmits the third shift data SFT3<7:0> to the exponent adder 765 and the mantissa shifter 766.

The exponent adder 765 receives the exponent selection data EX_SEL<9:0> output from the third multiplexer 746 of the exponent processing circuit 740. Also, the exponent adder 765 receives the third shift data SFT3<7:0> output from the “1” search circuit 764. An exponent adder 765 performs an addition operation on the exponent selection data EX_SEL<9:0> and the third shift data SFT3<7:0>, and outputs data generated as a result of the addition operation as the normalized exponent data EX_NOR<9:0>.

The mantissa shifter 766 receives the mantissa intermediate data MA_IMM<29:0> that is output from the multiplexer 763. Also, the mantissa shifter 766 receives the third shift data SFT3<7:0> that is output from the “1” search circuit 764. The mantissa shifter 766 shifts the mantissa intermediate data MA_IMM<29:0> in the rightward direction by the number of the mantissa shift bits, which is a decimal value of the third shift data SFT3<7:0>. The mantissa shifter 766 may leave only the upper 24 bits and remove all other lower bits during the shifting process. The mantissa shifter 766 outputs the data resulting from the shift as the normalized mantissa data MA_NOR<23:0>.

The addition operation of the exponent selection data EX_SEL<9:0> and the third shift data SFT3<7:0> in the exponent adder 765 and the shift operation of the mantissa intermediate data MA_IMM<29:0> in the mantissa shifter 766 are performed simultaneously at the time when the third shift data SFT3<7:0> is transmitted from the “1” search circuit 764. As described with reference to FIG. 24, because the time required for the addition operation in the exponent adder 765 is shorter than the time required for the shift operation in the mantissa shifter 766, the normalized exponent data EX_NOR<23:0> is output from the exponent adder 765 before the normalized mantissa data MA_NOR<23:0> is output from the mantissa shifter 766. The words “simultaneous” and “simultaneously” as used herein with respect to processes mean that the processes take place on overlapping intervals of time. For example, if a first process takes place over a first interval of time and a second process takes place simultaneously over a second interval of time, then the first and second intervals at least partially overlap each other such that there exists a time at which the first and second processes are both taking place.

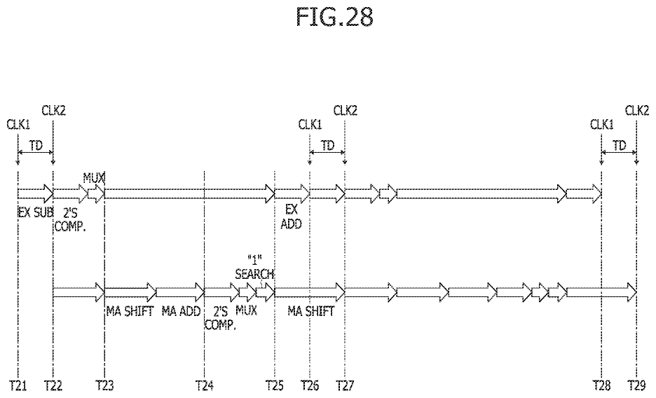

FIG. 28 is a timing diagram illustrating in more detail an example of a time required for the accumulating operation in the accumulator 700 of FIG. 21.

Referring to FIG. 24 together with FIGS. 25 to 27, at the first time point T21, the first exponent data EX1<7:0> and the second exponent data EX2<9:0> are transmitted from the exponent data latch circuit 710 to the exponent processing circuit 740 in synchronization with the first clock signal CLK1. From the first time point T21 to the third time point T23, the exponent subtraction operation EXSUB in the exponent subtractor 741, a 2's complement process 2'S COMP. in the 2's complement 742, and output operation MUX of the first shift data SFT1<7:0> and the second shift data SFT2<7:0> in the first multiplexer 744 and the second multiplexer 745 are performed in the exponent processing circuit 740.

At the second time point T22, the first mantissa data MA1<28:0> and the second mantissa data MA2<23:0> are transmitted from the mantissa data latch circuit 720 the mantissa processing circuit 750 in synchronization with the second clock signal CLK2. When the first shift data SFT1<7:0> and the second shift data (SFT2<7:0>) are transmitted from the exponent processing circuit 740 to the mantissa processing circuit 750 at the third time point T23, from the third time point T23 to the fourth time point T24, the mantissa shifting operation MA SHIFT in the first mantissa shifter 751A and the second mantissa shifter 751B, and the mantissa addition operation MA ADD in the mantissa adder 752A are performed in the mantissa processing circuit 750.

At the fourth time point T24, the normalization operation in the normalization circuit 760 starts to be performed. From the fourth time point T24 to the fifth time point T25, the 2's complement processing operation 2'S COMP. in the 2's complement circuit 761, the output operation MUX of the mantissa intermediate data MA_IMM<29:0> in the multiplexer 763, and the “1” searching operation “1” SEARCH in the “1” search circuit 764 are performed in the normalization circuit 760. When the third shift data SFT3<7:0> is output by the “1” search operation 1″ SEARCH in the “1” search circuit (764) at the fifth time point T25, from fifth time point T25 to the sixth time point T26, the exponent addition operation EX ADD is performed at the exponent adder 765 of the normalization circuit 760. And from the fifth time point T25 to the seventh time point T27, the mantissa shift operation MA SHIFT is performed at the mantissa shifter 766 of the normalization circuit 760. Accordingly, the normalized exponent data EX_NOR<9:0> is output from the normalization circuit 760 at the sixth time point T26 and the normalized mantissa data MA_NOR<23:0> is output from the normalization circuit 760 at the seventh time point T27. The operation from the sixth time point T26 when the second raising edge of the first clock signal CLK11 is occurred to the eighth time point T28 is generated is the same as the operation from the first time point T21 to the sixth time point T26. Similarly, the operation from the seventh time point T27 when the second raising edge of the second clock signal CLK12 is occurred to the ninth time point T29 is the same as the operation from the second time point T22 to the seventh time point T27.

A limited number of possible embodiments for the present teachings have been presented above for illustrative purposes. Those of ordinary skill in the art will appreciate that various modifications, additions, and substitutions are possible. While this patent document contains many specifics, these should not be construed as limitations on the scope of the present teachings or of what may be claimed, but rather as descriptions of features that may be specific to particular embodiments. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. An accumulator comprising:
an exponent data latch circuit configured to output first exponent data of input data and second exponent data of latch data in synchronization with a first clock signal;
a mantissa data latch circuit configured to output first mantissa data of the input data and second mantissa data of the latch data in synchronization with an edge of a second clock signal delayed by a delay time period later than an edge of the first clock signal;
an exponent processing circuit configured to perform an exponent processing operation that generates first shift data and second shift data based on the first exponent data and the second exponent data transmitted from the exponent data latch circuit; and
a mantissa processing circuit configured to shift the first mantissa data and the second mantissa data transmitted from the mantissa data latch circuit by the first shift data and the second shift data, respectively.

2. The accumulator of claim 1, further comprising a clock generation circuit,
wherein the clock generation circuit includes:
a first clock generator configured to generate the first clock signal based on a reference clock signal and to transmit the first clock signal to the exponent processing circuit; and
a second clock generator configured to generate the second clock signal based on the first clock signal and to transmit the second clock signal to the mantissa processing circuit.

3. The accumulator of claim 2,
wherein the second clock generator includes a delay circuit that generates the second clock signal by delaying the first clock signal for the delay time period.

4. The accumulator of claim 1,
wherein the delay time period is set to a time shorter than the time during which the exponent processing operation is performed in the exponent processing circuit.

5. The accumulator of claim 1, further comprising a normalization circuit,
wherein the exponent processing circuit is configured to output exponent data having a larger value among the first exponent data and the second exponent data as exponent selection data,
wherein the mantissa processing circuit is configured to output mantissa addition data obtained by adding first shifted mantissa data and second shifted mantissa data, the first shifted mantissa data being obtained by shifting the first mantissa data by the first shift data, and the second shifted mantissa data being obtained by shifting the second mantissa data by the second shift data,
wherein the normalization circuit is configured to perform an exponent addition operation for the exponent selection data and to perform a mantissa shifting operation for the mantissa addition data or 2's complement of the mantissa addition data, and
wherein the delay time period is set to a time corresponding to a time difference between the time required for the mantissa shifting operation and the time required for the exponent addition operation in the normalization circuit.

6. The accumulator of claim 1, wherein the exponent data latch circuit includes:
a first flip-flop configured to latch the first exponent data and to output the first exponent data in synchronization with the edge of the first clock signal; and
a second flip-flop configured to latch the second exponent data and to output the second exponent data in synchronization with a raising edge of the first clock signal.

7. The accumulator of claim 6, wherein the mantissa data latch circuit includes:
a third flip-flop configured to latch the first mantissa data and to output the first mantissa data in synchronization with the edge of the second clock signal; and
a fourth flip-flop configured to latch the second mantissa data and to output the second mantissa data in synchronization with a raising edge of the second clock signal.

8. The accumulator of claim 1, wherein the mantissa processing circuit includes:
an exponent subtractor configured to output exponent subtraction data by performing a subtraction operation for subtracting the second exponent data from the first exponent data;
a 2's complement circuit configured to generate 2's complement of the exponent subtraction data output from the mantissa subtractor;
a first multiplexer configured to output “0” or the 2's complement of the exponent subtraction data as the first shift data based on the most significant bit of the exponent subtraction data; and
a second multiplexer configured to output the exponent subtraction data or “0” as the second shift data based on the most significant bit of the exponent subtraction data.

9. The accumulator of claim 8,
wherein the exponent processing circuit includes a third multiplexer that outputs the first exponent data or the second exponent data as exponent selection data based on the most significant bit of the exponent subtraction data.

10. The accumulator of claim 9,
wherein third multiplexer is configured to:
output the first exponent data as the exponent selection data when the most significant bit of the exponent subtraction data is “0”, and
output the second exponent data as the exponent selection data when the most significant bit of the exponent subtraction data is “1”.

11. The accumulator of claim 8,
wherein first multiplexer is configured to:
output “0” as the first shift data when the most significant bit of the exponent subtraction data is “0”, and
output the 2's complement of the exponent subtraction data as the first shift data when the most significant bit of the exponent subtraction data is “1”.

12. The accumulator of claim 8,
wherein second multiplexer is configured to:
output the exponent subtraction data as the second shift data when the most significant bit of the exponent subtraction data is “0”, and
output “0” as the second shift data when the most significant bit of the exponent subtraction data is “1”.

13. The accumulator of claim 1, wherein the mantissa processing circuit includes:
a first mantissa shifter configured to shift the first mantissa data by the number of first shift bits that correspond to the first shift data to generate first shifted mantissa data;
a second mantissa shifter configured to shift the second mantissa data by the number of second shift bits that correspond to the second shift data to generate second shifted mantissa data; and
a mantissa adder configured to add the first shifted mantissa data and the second shifted mantissa data to generate mantissa addition data.

14. The accumulator of claim 13,
wherein shifting operations of the first mantissa shifter and the second mantissa shifter are performed in the right direction of a binary point, respectively.

15. The accumulator of claim 13,
wherein the mantissa adder outputs sign data representing a sign of the mantissa addition data.

16. The accumulator of claim 15, further comprising a normalization circuit,
wherein the exponent processing circuit is configured to output exponent data having a larger value among the first exponent data and the second exponent data as exponent selection data,
wherein the normalization circuit is configured to perform a normalizing process based on the exponent selection data and the mantissa addition data to output normalized exponent data and normalized mantissa data,
wherein the normalization circuit includes:
a 2's complement circuit configured to generate 2's complement of the mantissa addition data;
a multiplexer configured to output the mantissa addition data or the 2's complement of the mantissa addition data as mantissa intermediate data based on the sign data;
a “1” search circuit configured to search a position in which a binary number of “1” is first located in a right direction from a leftmost bit of the mantissa intermediate data and configured to output the search result as third shift data;
an exponent adder configured to generate the normalized exponent data by adding the exponent selection data and the third shift data; and
a mantissa shifter configured to generate the normalized mantissa data by shifting the mantissa intermediate data by the number of bits that correspond to the third shift data.

17. The accumulator of claim 16,
wherein an addition operation of the mantissa adder and a shifting operation of the mantissa shifter are performed simultaneously when the third shift data is transmitted from the “1” search circuit, and
wherein a time point at which the normalized exponent data is output from the exponent adder is earlier than a time point at which the normalized mantissa data is output from the mantissa adder by the delay time period.
